(19) United States
(12) Patent Application Publication
(10) Pub. No.: US 2019/0197112 A1
(43) Pub. Date: Jun. 27, 2019

(54) Computer system of an artificial intelligence of a cyborg or an android, wherein a received signal-reaction of the computer system of the artificial intelligence, a corresponding association of the computer system of the artificial intelligence, a corresponding thought of the computer system of the artificial intelligence are physically built, and a working method of the computer system of the artificial intelligence of the cyborg or the android

(71) Applicant: Boris Kaplan, Munich (DE)

(72) Inventor: Boris Kaplan, Munich (DE)

(21) Appl. No.: 16/288,154

(22) Filed: Feb. 28, 2019

(51) Int. Cl. G06F 17/27; G06F 16/22; G06F 12/06

(52) U.S. Cl. CPC G06F 17/2785; G06N 20/00; G06F 12/06; G06F 16/2282

(57) ABSTRACT

A computer system of an artificial intelligence of a cyborg or an android, wherein a received signal-reaction of the computer system of the artificial intelligence, a corresponding association of the computer system of the artificial intelligence, a corresponding thought of the computer system of the artificial intelligence are physically built, and a working method of the computer system of the artificial intelligence. The computer system is based on one natural language. The computer system comprises at least five senses equipped with sense organs, wherein the senses are a sense of sight, a sense of hearing, a sense of smell, a sense of taste, a sense of touch. The sensors network summarizes all reactions of all sensors of all sensor groups of all sense organs of all senses. For another natural language, the computer system uses the references to the thoughts of this computer system.

Computer system of an artificial intelligence of a cyborg or an android, wherein a received signal-reaction of the computer system of the artificial intelligence, a corresponding association of the computer system of the artificial intelligence, a corresponding thought of the computer system of the artificial intelligence are physically built, and a working method of the computer system of the artificial intelligence of the cyborg or the android.

### TECHNICAL FIELD

The present invention relates to a computer system of an artificial intelligence of a cyborg or an android, wherein a received signal-reaction of the computer system, a corresponding association of the computer system, a corresponding thought of the computer system of the artificial intelligence are physically built, and to a working method of the computer system of the artificial intelligence of the cyborg or the android. The computer system is based on one natural language.

### BACKGROUND OF THE INVENTION

Systems of artificial intelligence for the classification of events, objects or situations, for example, which provide the classification of seismic events, are known from the European patent (FR 9908472, DE 60005350). The systems are based on the fuzzy expert system (FES). That invention is not planned as a computer system of artificial intelligence of a cyborg or an android as well as it is not based on one natural language.

From the European patent (JP 32376590, DE 69132026), a software work tool, which is used in software work for an information processing apparatus, is known. It manages software on the field of the artificial intelligence dynamically. The point from that invention is not a computer system of artificial intelligence of a cyborg or an android. It is about the tool, which manages the software to run-time intelligently and dynamically.

A system for adding attributes to an object at run-time in an object oriented computer environment is known from the European patent (US 96112432, DE 69616449). In that system, the procedure for assigning a property to an object by a computer system is implemented. The computer system contains a definition of a class, which specifies one or several class properties from an object, and the computer system adds attributes to an object to compile time at run-time. The point from that invention is not a computer system of artificial intelligence of a cyborg or an android. By object modeling, it is about the use of a computer language and a compiler.

A system and method using natural language understanding for speech controlled application are known by the European patent (US 93293897, DE 69814114). That invention relates, in general to computerized natural voice systems, in particular to a computer system and method for providing speech understanding abilities to an interactive voice response system or a computer system and method to interpreting of utterances by a speech recognition application, provided with boundary conditions. The computer system is based on a fix, predetermined, annotated ASR corpus file, which contains an enumeration of all expected valid utterances. That invention is not planned as a computer system of artificial intelligence of a cyborg or an android.

In the European patent (EP 93918750, DE 69303013), the use of a language with a similar representation for programs and data by the distributed data processing is patented. That invention is based on a computer language.

By the European patent (KR 2003000254, DE 10361726), a robot toy with artificial intelligence and control method for it are patented. Several patent claims specific for a robot are disclosed by the patent. The artificial intelligence of the robot toy is planned for its mechanical control.

From the American patent (U.S. Pat. No. 5,963,663 A), a land mark recognition method for mobile robot navigation is known. Signs (the land marks) are identified as objects in that invention. In the invention, with help of an object recognition apparatus, which works after the principle of the pattern recognition of the neuronal net, a pattern of a signal is differentiated from another pattern. The input signal is decomposed on the red value, the green value and the blue value for the pattern recognition. The invention makes it possible that a robot can execute the different technical tasks, for example, to transport objects in plants. The main point of that invention is not a computer system of artificial intelligence of a cyborg or an android.

The article “A survey of socially interactive robots”, T. Fong, I. Nourbakhsh, K. Dautenhahn, Robotics and Autonomous Systems 42 (2003), pp. 143-166, is relevant to the state of the related art. That article is focused on social peer-to-peer human-robot interaction (HRI). The important topics of the article are:
1. design of a robot for human-robot interaction, for example, “For this reason, more and more robots are being equipped with faces, speech recognition, lip-reading skills, and other features and capacities that make robot-human interaction “human-like” or at least “creature-like”” or the material, for example, “The form and structure of a robot is important because it helps establish social expectations”;
2. emotions of humans during human-robot interaction, for example:
2.1. “The primary parameters that govern the emotional content of speech are loudness, pitch (level, variation, range), and prosody”;
3. human-robot dialogue during human-robot interaction, for example:
3.1. “ . . . a robot dog learns simple words describing the presence of objects (ball, red, etc.), its behavior (walk, sit) and its body parts (leg, head)”;
3.2. the language recognition can be used by navigation, obstacle avoidance, etc. or by a museum tour;
3.3. “To what extent human-robot interfaces should be based on natural language remains clearly an open issue”;
4. creating robots for human-robot interaction which can imitate humans:
4.1. “In order for imitation to be useful, the robot must decide not only when to start/stop imitating, but also when it is appropriate . . . ”;
5. difference between conventional and socially interactive robots, the artificial social agents:
5.1. “A key difference between conventional and socially interactive robots is that the way in which a human perceives a robot establishes expectations that guide his interaction with it”.

The article “Toward Building a Social Robot with an Emotion-Based Internal Control and External Communication to Enhance Human-Robot Interaction”, Andreas Hendro Marpaung, B. S. University of Central Florida, 2002, is relevant to the state of the related art. In the article of Andreas H. Marpaung, the following topics are described, for example:
1. a natural language: “The avatar is present on the laptop/Cherry's user interface and has voice ability so that she can speak to the user in natural language. She explains a variety of facts, from who she is and what her mission is, namely the UCF computer science tour guide, to which professor works in what office, to what that particular professor is researching.”
2. emotions: “Lola is also capable of displaying her current emotion states that follows the same emotion transitions as in Cherry's but are triggered differently. Unlike Cherry, whose emotions are triggered by the open or closed door and the recognized or unrecognized person, Lola's emotions are triggered because of the repetitive tasks that need to be performed following these rules:
If PERFORMITR==0 then EMOTION-LIKE-STATE=“Happy”
Elseif PERFORMITR==2 then EMOTION-LIKE-STATE=“Frustrated”
Elseif PERFORMITR==4 then EMOTION-LIKE-STATE=“Discouraged”
Elseif PERFORMITR==6 then EMOTION-LIKE-STATE=“Angry”
where PERFORMITR is the frequency of the same task performed sequentially represented by numerical values between 0 and 6, and EMOTION-LIKE-STATE is her emotion state (Happy, Frustrated, Discouraged, Angry ε EMOTION-LIKE-STATE). For example, she feels frustrated if she needs to introduce herself more than twice.”
3. behavior: “This behavior can be further divided into three broad categories: reflexive behaviors, “hardwired” responses to the stimuli so the response time can be shortened; reactive behaviors, learned behaviors that then can be produced without conscious thought; and conscious thought, deliberate behaviors. Out of these three types, the reflexive behavior was chosen for this project because the sensory motor level responds to the stimuli.
After the perceptual system filters the stimuli, the system sends them to the ESG. They are then forwarded to the BSG. Currently, the BSG is built as a simple mechanism that helps smoothen the navigation by centering the robot in the middle of the aisle and avoiding any simple obstacles. Through these outputs from the perceptual systems, the robot can execute different behaviors depending on the input source. Each behavior state is described below:
INIT: Reset the emotion and the progress bars to the default setting—happy—and the initial position to room 204.
STAY_CENTER: Center herself between the aisles to avoid the walls.
AVOID_LEFT_WALL: Move to the right to avoid the left wall. This behavior is triggered should course correction calculated by sonar and/or vision be needed.
AVOID_RIGHT_WALL: Move to the left to avoid the right wall. This behavior is triggered should the course correction be needed . . . ”

In this article, a received signal-reaction of a cyborg or an android, a corresponding association of a cyborg or an android, and a corresponding thought of a cyborg or an android are not physically substantiated. The received signal-reaction of a cyborg or an android is not the same as a signal or some signals of sensors of a sense. An association of a cyborg or an android is not taken into consideration in the article. The thoughts of a cyborg or an android are not described in detail in the article. A received signal-reaction of a cyborg or an android, a corresponding association of a cyborg or an android, and a corresponding thought of a cyborg or an android are also not a subject matter of the article.

The article “Towards Development of Multilingual Spoken Dialogue Systems”, Interactive Systems Laboratories, Universität Karlsruhe, Germany, of Hartwig Holzapfel is relevant to the state of the related art. The article is about:
1. “We describe our experiences with designing multilingual dialogue systems and present methods for multilingual grammar specification, as well as development and maintenance methods for multilingual grammars used for language understanding, and multilingual generation templates.”
2. “We use the option of Ibis to decode with context free grammars (CFG) instead of statistical n-gram language models (LM).”;
3. “4.1. Multilingual Grammars with Grammar Inheritance” “Vectorized context free grammars are similar to (semantic) context free grammars, in that they exist of a set of nonterminal symbols, a set of terminal symbols, a set of rules and a set of start symbols, and semantic annotation of right hand side elements of a rule. In addition, vectorized context free grammars allow multiple inheritance of nodes and definition of vectorized nonterminal symbols. A vectorized nonterminal consists of a vector <e1, e2, . . . , en> where ei is an element of a partially ordered set Vi.”;
4. “The following code line shows an invocation of a template function informing the user that a given object is available.
#Available {$objs.first.[OBJ|NAME]}
The String “$objs.first.[OBJ|NAME]” calls a dialogue variable by accessing discourse information with the given typed feature structure path “[OBJ|NAME]”.”;
5. “Using grammar interfaces and rule inheritance, the definition of a rule containing the name of a lecture looks as follows. A rule interface (frame definition)
iframe <act_askPlace,VP,_>=
<obj_Place,N_,_>{PLACE obj_Place}
requires that the rule <obj Place,N, ,> is defined in all implementing language specific grammars. Then two rules, one for English (with language tag EN)<obj Place,N, ,EN> and one for Spanish (with language tag ES)<obj Place,N, ,ES> are specified. The right hand side of both rules contains a database import instruction. The import statement specifies the database location, table, field, and semantic value.
<obj_Place,N,_,ES>=import
$db Lecture PlaceES {PLACE import}”.
The article “Data Models in Database Management”, E. F. Codd, IBM Research Laboratory, San Jose, Calif. 95193, is relevant to the state of the related art. The article is about:
“1 WHAT IS A DATA MODEL?
It is a combination of three components:
1) a collection of data structure types (the building blocks of any database that conforms to the model);
2) a collection of operators or inferencing rules, which can be applied to any valid instances of the data types listed in (1), to retrieve or derive data from any parts of those structures in any combinations desired;
3) a collection of general integrity rules, which implicitly or explicitly define the set of consistent database states or changes of state or both—these rules may sometimes be expressed as insert-update-delete rules.”
“2 PURPOSES OF A DATA MODEL
A data model may be used in any of the following ways:
1) as a tool for specifying the kinds of data and data organization that are permissible in a specific database;
2) as a basis for developing a general design methodology for databases;
3) as a basis for coping with evolution of databases so as to have minimal logical impact on existing application programs and terminal activities;
4) as a basis for the development of families of very high level languages for query and data manipulation . . . ”;

Primary Keys:
“Likewise, primary keys (whether they have system-controlled surrogates or user-controlled identifiers as values) are at a higher level than pointers. A particular occurrence of a value V of a primary key makes reference to all other occurrences of V in the database that are drawn from the domain of that primary key. Surrogates have the property that they are distinct if they represent distinct objects in the real world. They are at a higher level than DBTG database keys, which are record identifiers that are distinct for distinct records. Note that there may be two or more records describing a single real world object, in which case there are two or more database keys corresponding to one surrogate. Moreover, within one record there may be two or more surrogates and only one database key.”

A robot control system and method for introducing robot control software is known from American patent (U.S. Pat. No. 6,760,648). That invention is about:
1. “The present invention has been developed in view of the above objects, and in one aspect relates to a robot control system which controls a robot including a combination of a plurality of hardware elements using a hardware dependent software program and a hardware independent software program. The robot control system includes hardware independent software program providing means for providing the hardware independent software program, hardware dependent software program providing means for providing at least one hardware dependent software program, hardware configuration information acquisition means for acquiring hardware configuration information of the robot, hardware dependent software program selection means for selecting a hardware dependent software program, compatible with the hardware configuration information acquired by the hardware configuration information acquisition means, in the hardware dependent software providing means, and software introduction means for introducing, into the system, the hardware independent software program provided by the hardware independent software program providing means, and the hardware dependent software program selected by the hardware dependent software selection means.”
2. “The present invention in a second aspect relates to a robot control software program introducing method for introducing a hardware dependent software program and a hardware independent software program into a robot including a combination of a plurality of hardware configuration elements, and includes a hardware independent software program providing step for providing the hardware independent software program, a hardware dependent software program providing step for providing at least one hardware dependent software program, a hardware configuration information acquisition step for acquiring hardware configuration information of the robot, a hardware dependent software program selection step for selecting a hardware dependent software program, compatible with the hardware configuration information acquired in the hardware configuration information acquisition step, and provided in the hardware dependent software providing step, and a software introduction step for introducing, into a system, the hardware independent software program provided in the hardware independent software program providing step, and the hardware dependent software program selected in the hardware dependent software selection step.”
3. “The present invention in a third aspect relates to a robot control system which controls a robot including a combination of a plurality of hardware elements using a hardware dependent software program and a hardware independent software program, wherein the hardware independent software program and/or the hardware dependent software program is provided by a memory device which is permanently fixed to the body of the robot and a memory device which is replaceably mounted to the body of the robot, wherein the robot control system controls the robot in one of a best match operation mode, an intercompatible operation mode, and a fixed operation mode, and wherein in the best match operation mode, the robot is controlled using the hardware dependent software program and the hardware independent software program introduced from the exchangeable memory, in the intercompatible operation mode, the robot is controlled using the hardware dependent software program introduced from the fixed memory device and the hardware independent software program introduced from the exchangeable memory device, and in the fixed operation mode, the robot is controlled using the hardware dependent software program and the hardware independent software program introduced from the fixed memory device.”

The article “Sensor-based robot motion generation in unknown, dynamic and troublesome scenarios”, J. Minguez, L. Montano, Robotics and Autonomous Systems 52 (2005), pp. 290-311, is relevant to the state of the related art. The article is about:
1. an autonomous navigation system of robots for “robust and trustworthy navigation in very complicated environments”;
1.1. “e.g., robots that transport dangerous materials”;
2. that “the sensor-based motion control subsystem was developed to move the vehicle to the desired positions” (i.e. from point A to point B) “without collisions. This functionality is only a subset of the complete mobility problem”;
3. the environment of the robot; the environment, which is relevant for the article, are obstacles, which move around the robot;
4. that the robot computes over and over again a path from the robot location to the destination with help of three arts of modules in a troublesome environment (in a troublesome dynamic changed environment as well);
5. that the techniques, which are described in the article, “would increase the degree of autonomy of the robots and reduce human intervention”;
6. that the authors “ . . . present a sensor-based motion control system as a subset of a complete navigation system”.

“Sensor and actuator abstraction and aggregation in a hardware abstraction layer for a robot” are known from American patent (US 2003/0171846 A1).
1. That patent is about hardware driver for robot, which are installed “between robot control software and underlying robot hardware and/or an operating system for the hardware”:
1.1. “In particular, the invention relates to a hardware abstraction layer (HAL) that enhances portability of control or behavior software”, which “permits robot control software to be written (by developers) in a robot-independent manner” and “efficiently permits robot control software developed for one robot to be ported to another”;
1.2. HAL implements resource software drivers, which are installed between “the lower-level device drivers” and “the higher-level robotic software with real-world measurements relating to robot interaction with an environment”, “wherein the higher-level software includes at least one selected from the group consisting of a planner, an application, a behavior, and a task”;
1.3. “one embodiment includes a computer-readable medium having computer-executable instructions for performing the method of providing hardware abstraction. The computer-readable medium can correspond to a wide variety of mediums including, but not limited to, hard disks, floppy disks, and other magnetic disks, RAM, ROM, Flash Memory, Memory Cards, and other solid-state memory, optical disks, CD-ROMs, DVD-ROMs, and the like”;
1.4. the “IResourceDriver”, “IResource”, “IRSensor”, “IResourceContainer” oder “Implemenmented Resource Interfaces” (“IAudioBase”, “IAudioLevel”, “ICamera”, “ICamera Group”, “IBumpSensor”, “IRangeSensor”, “ISpitalSEnsor”, “IFace”, “IMotorCommand”, “IMotorQuery”, “IDriveSystem”, “IOdometry”, “IImageDisplay”, “IJoystick”, “ISwitchDevice”, “IGripper”, “ISpeechRecognizer”, “ISpeechTTS”, “IPollable”, “ITransactable”) etc. are developed in a programming language (C++);
2. the invention generally relates to robotics and makes it possible that a robot can physically execute a robot task, for example, to go, to pick up or to smile or also for example in order that the robot dog can physically execute “to wag its tail”.

A non-linear genetic process for use with plural co-evolving populations is known from American patent (U.S. Pat. No. 5,148,513 A). That invention is about:
1. computer programs, source code, “Expressions such as (−(*5 4) (*3 2)) in LISP are called symbolic expressions (S-expressions)”; “It is helpful to graphically depict a functional programming language's expressions”;
2. programming language LISP, “This seeming simplicity gives LISP enormous flexibility (including the flexibility to accommodate computational procedures which modify themselves and execute themselves). This enormous flexibility makes LISP the preferred computer language for the present invention”;
3. computer programs, that are represented as entities, for example, “FIG. 12 illustrates a simple entity, namely the symbolic expression in the LISP programming language for the mathematical expression A+B*C”;
4. “populations of programs of various sizes and structures and wherein more than one program can be executed simultaneously” parallel in an environment;
5. “co-evolution” process of the populations of the computer programs, “The atom set and function set for the “co-evolution” process is the same as for the “non-linear genetic process””;
6. “co-evolution” process of the populations of the computer programs with (“co-evolving”) “of populations as the evolving population” of the computer programs and “the remaining populations” of the computer programs;
7. that the invention can be used, for example, in computer games, where a highly competent player needs the computer game difficult configured, or rather for an optimal strategy of player, “Co-evolution is likely to be especially important in competitive situations (i.e. games) because one almost never has a priori access to an optimal strategy for either player”.

The Universal machine translator of arbitrary languages is known from American patent (U.S. Pat. No. 6,341,372). That invention is about a thinking machine for translation of arbitrary languages (indirectly about androidal forms of existence and the artificial intelligence), the Universal Epistemological Machine (U.M.), the Modal Realization System (MRS), the general resultant modules (Rg module), the Rg continuum etc.:
1. “The TRS” (the translation system) “thus parses arbitrary source language syntax A for decomposition into the U. G.” (the universal grammar) “structures of the invention (epistemic instances), translates epistemic instances derived from A to epistemic instances derived from language B and then constructs the syntax and word streams of language B. This method, embodied in appropriate electronic or other apparatus, in conjunction with techniques of voice and character synthesis (generation) and recognition thus achieves an universal machine translator of language analogously to the way in which a human translator would translate language (ideally)—on the basis of the translation of the meanings of the languages involved”;
2. “Knowledge, the appearance of the mind's objects, is what is enabled as the form of consciousness; to the knower, it is an epistemic instance of a cognitive universe—a thought. Perception is the appearance to us of the world's objects; it is also an epistemic instance but of the corporal sensation of the world around us. Any form is an instance of our knowing and perceiving of the world around us, arising from beyond our knowing, as a state of being, or Soul”;
3. “ . . . a language construction of human existence may objectify the universe in, for example, the use of ten or even twenty word compositions as subjects of sentences before proceeding cognitively to the transformation, or verb, of the sentence with one other such objectification, the androidal faculty of mind is capable of cognitively formulating objects of the universe, in any languages, in objectifications of the universe (word associations) composed so great in number they require the mathematical definitions of the infinite to account for them, before proceeding to the action (verb) of a sentence”;
4. “To do this, the machine compares the word forms, successively, to an embodiment (database) DB1 (277) of preexisting associations between the word form in its sensory/motor (real communicative) form and its possible grammatical arrangements in the source languages' grammar. The machine thus identifies the word forms in succession with their grammatical equivalents until a rule truncates the incoming word stream upon recognition of a high-level construction”.

That Universal Epistemological Machine does not physically substantiate the received signal-reaction of a cyborg or an android, the corresponding association of a cyborg or an android, and the corresponding thought of a cyborg or an android. The received signal-reaction of a cyborg or an android is not signals of sensors of a sense, the association of a cyborg or an android is not only a “word association”, the thought of a cyborg or an android is not a sentence. The Universal Epistemological Machine works with its “word associations” in two or more natural languages, but a system of artificial intelligence of a cyborg or an android does not. The Epistemology and the Computer Science (meaning area of class-based model of OOP) are different fields of science.

The linguistic object model is known from American patent (U.S. Pat. No. 7,171,352). That patent is about a programming language (a computer language) (SPL) and a framework of that programming language (of that computer language) (LOM):
1. “The present invention is a Linguistic Object Model (LOM), a semantic framework, and a semantic programming language (SPL) for producing natural language applications. The LOM models semantic utterances independent of the natural language used or the application domain involved”;
2. “The semantic programming language (hereinafter referred to as “SPL”) is intended to assist software application developers to implement natural language programs.” (For example, by developing software for mail agent (a e-mail program).) “Since most developers are not experts in semantic analysis or linguistics, the SPL provides a framework and a programming language for non-linguist developers to deal with natural language semantics in largely intuitive ways”;
3. “In general, the LOM is implemented as a class library of the SPL. This is similar to the way that the C Runtime Library and the Standard Template Library (STL) form the standard library of, for example, Microsoft® Visual C++®, which is an application designed to facilitate software development and which was created by Microsoft Corporation of Redmond, Wash. The terms Microsoft® and Visual C++® are trademarks owned by Microsoft Corporation of Redmond, Wash.”;
4. “In one embodiment, the framework” (of the semantic framework of a semantic programming language (SPL)) “types are implemented as types in the NET Framework, which is a framework that was created by Microsoft® Corporation of Redmond, Wash.”;
5. The SPL is an object-oriented computer language;
6. computer program code of a computer language (SPL), for example:
6.1. “Entity BookEntity denoted by “book” {on resolve {with frame discuss<DoneTo.what:=string>; }}”;
6.2. “SendMailCommand uses SendMailFrame {on resolve {on begin {return Outlook.IsInSendMailContext( );} on success {Outlook.SendMail(SendMailFrame.Mail, SendMailFrame.Targets);} on failure {II do whatever cleanup is necessary}}}”.

The field of that patent is not AI (the artificial intelligence). The theme of the patent is not a computer system of artificial intelligence of a cyborg or an android. The principal topic of that patent are not the received signal-reaction of a cyborg or an android, the corresponding association of a cyborg or an android, and the corresponding thought of a cyborg or an android. That patent is not about the thought substance of a cyborg or an android to the corresponding association substance of a cyborg or an android as well as the thought substance of a cyborg or an android is not a word or a semantic utterance.

“Method and system for automatic computation creativity and specifically for story generation” are known from American patent (U.S. Pat. No. 7,333,967). That patent is about a computer system and the method, which generates a story automatically, indirectly about the computational engines, termed the “creative agent”, about “the foundation for engineering creative agents that generate interesting stories, scripts, adventure games, musical compositions, recipes, paintings, sculptures etc.”, about FLEX, an expert rule-based system toolkit (fuzzy logic) “based in the programming language Prolog. It is commercially available from Logic Programming Associates, Ltd., incorporated in the United Kingdom”:
1. “Generally, a story is a natural language description of objects, their attributes, relationships, behaviors and interactions . . . . However, all stories include a description of some set of objects and their interactions”;
2. “Objects described in the domain knowledge-base are interrelated and linked to linguistic concepts (e.g., words, phrases, etc.) as one way of capturing literary knowledge. The resulting associations between concepts and language elements are called “literary associations”. They are used to generate sentences that satisfy specific literary objectives”;
3. “FLEX provides the developer with complete access to Prolog” (Prolog is a computer language) “and enhances the paradigm with frame-based structures, relations, production rules, and an English-like syntax”;
4. converting some “formal, logic based language independent of a spoken language,” language representations to a natural language;
5. “Domain knowledge (e.g., 100A1) encodes a formal representation of objects, attributes, relationships, goals, behaviors, and events (e.g., a formal description of a domain). Domain knowledge is not the story itself, but is a description of a collection of concepts about which some story may be written”;
6. “The final level in the grammar hierarchy is composed of literary-augmented sentence grammars (LAGs), which are formal language grammars that represent components of English syntax augmented with literary constraints.”

The principal topic of that patent is not a computer system of artificial intelligence of a cyborg or an android. That patent is not about the received signal-reaction of a cyborg or an android, the corresponding association of a cyborg or an android, and the corresponding thought of a cyborg or an android. A “literary association” is not an association of a cyborg or an android. The toolkit of that patent (meaning a framework) works in a formal language. A formal language is not a natural language.

From the publication “Information Technology of the Five Senses”, National Institute of Advanced Industrial Science and Technology (AIST), Japan, 2005 is known a collection of diverse scientific articles:

The first article is “Research on the Five Senses by AIST is making great strides”, Michitaka Hirose, Research coordinator (Information Communications) (Pages 2, 3). That article is about:
1. “Information Technology of the Five Senses seen from the social perspective. During the last several years, the terminology of “Information Technology on five Senses” has garnered attention from various areas. As far as I remember, that wording was first used in a report submitted by the Electrical Communications Technology Meeting: “Basic Plan on Information Communications Research Development”. My recollection of that time paints it as a suggestion that we would need to investigate such a new field and to explore it because we had entered into a situation in which new information interface technologies, such as virtual reality (VR) technology, were beginning to be introduced. More than four years have passed since then. and this wording now seems to imply that this technology is rather closer to the industrial world in addition to its recognized importance as a keyword in research work.”
2. “One more interesting aspect of technology is that information technology itself has changed to a mobile-type: it is becoming much clearer to everyone that we are facing a new phase of technology. Mobile-type information processing can function while the user is moving physically from one place to another.”
3. “I feel sure that Information Technology of the Five Senses is the vanguard of new current in our industrial world that has tended toward a standstill.”

An article is “Focusing on multiple sounds using super-distributed microphones and speakers”, Satoshi Kagami, Humanoid Interaction Team Leader, Digital Human Research Center (Page 4). That article is about:
1. “Listen and recognize a sound. Then emit it to wherever intended. Our environment always includes a vast number of flowing sounds. We human beings listen unconsciously to what we think we need. Robots, however, would be incapable of picking up only the information they need out of the sounds captured by a microphone. In addition, no technology has yet been established to provide a sound to a specific place at home or in the office. In light of these facts, we are researching, using numerous microphones and speakers, a means to allow us to provide sound only to those places that need it, or to catch sounds that exist only in the place we specify.”
2. “What can we do with super-distributed microphones and speakers?
A set of super-distributed microphones can capture and recognize one sound from all the different sounds that are audible from various directions . . . ”

An article is “Organic device in ubiquitous information society”, Kiyoshi Yase, Deputy Director, Photonics Research Institute (Page 5). That article is about:
1. “Development of organic EL devices that capture outside light efficiently. Our research group is Working on development of “photo-responsive organic EL devices” by putting a layer of a photoelectric transducer (organic photo conductor (OPC)) into an organic EL device. Emitting light to that device, photo are produced at the OPC layer. The carriers are then injected into the organic EL layer, thereby improving its intensity.”
2. “Development of n-type organic TFT of high performance by applying spin-coating method. In addition, organic TFF is now receiving attention for use in RF»ID tag or organic EL, which is driven by organic TF1” circuit. Particularly, the development of organic semiconductors that are soluble in solvents is becoming more popular recently because, if done successively, it would allow production of organic TFTs with a large area at low cost by the associated printing law. Our research group newly developed the C60 derivatives (C60MCl2).”

An article is “Haptic Displays—Information Displays for the Sense of Touch”, Juli Yamashita, Institute for Human Science and Biomedical Engineering Skill Research Group (Page 6). That article is about:
1. “A “haptic display” is a device that enables us to “touch and feel” information in a computer.”
2. “Various haptic displays. In the last two decades, many kinds of haptic displays have been researched and developed . . . ”

An article is “Research and development of olfactory displays”, Yasuyuki Yanagida, Meijo University/Advanced Telecommunications Research Institute International (ATR) (Page 7). That article is about:
1. “Among others. VR-oriented olfactory displays are actively pursued in Japan. For example, a wearable olfactory display has been developed at the University of Tokyo that can supply odors to a person who walks around in a VR space. An a.rn1-mounted interactive olfactory display has been developed at Nara Institute of Advanced Science and Technology, focusing on the behavior when a person tries to pick up something to smell. In ATR, a scent projector, which delivers the odor locally to the nose without requiring a user to wear anything on the face. has been developed.”

An article is “Obstacle perception training system for rehabilitation use”, Yoshikazu Seki, Accessible Design Group, Institute for Human Science and Biomedical Engineering (Page 8). That article is about:
1. “Perception to recognize a silent object. “Obstacle perception” is the ability to sense the existence of an object (like a wall, for example) that makes no sound. It is achievable using hearing based on the reflection or insulation of other sounds in the environment which is an important environmental perception capability used by visually impaired persons. Training to have visually impaired people perceive obstacles around them is an important factor in the education or rehabilitation to allow them join and participate in society. However, that acoustic mechanism remains little understood. For that reason, current training must rely mostly on as much experience as they can get.”
2. “Obstacle perception training system. Against that background described previously, we aggressively investigated this issue to elucidate the acoustic mechanism for obstacle perception. We developed a new training method to utilize acoustic technology ahead of the rest of the world so that training can be accomplished more: scientifically.”
3. “The first developed “Obstacle Perception Training System” is capable of calculating the activity of an acoustic field surrounding an obstacle”
4. “One problem is that the resultant “Obstacle Perception Training System” is so expensive and large-scale that it is difficult to use in the real world where training for visually impaired persons is conducted or where rehabilitation is taking place. To surmount that obstacle, we have developed and are providing an “Sound Field CD for Obstacle Perception Training” which is recorded with acoustic data that reproduces a virtual obstacle so that the training can be accomplished at home using an ordinary home audio device . . . ”

An article is “Remote support system for visually impaired persons”, Iwao Sekila, Advanced Semiconductor Research Center (Page 9). That article is about:
1. “Software for transmitting video images and voice signals. A data compression technique is necessary to transmit video images and voice signals via the wireless network based on a cellular phone (PHS). We have developed and are improving an adaptable BTC compression technique that has a characteristic of keeping shapes of characters even in strong compression because character information is important for assistance. We are also improving the adaptive technique for adjusting to legible brightness of images.”

An article is “Tactile sensor based on a thin-film semiconductor”, Michiru Sakamoto, Director of On-site Sensing and Diagnosis Research Laboratory (Page 10). That article is about:
1. “We have researched and developed at thin film of aluminum nitride (AlN), which has a number of splendid features to satisfy these requirements to use as a sensor device. Its technical characteristics dictate that we can have a wide selection of substrates for production of a thin membrane from metal foils to high polymer films, for example.”

An article is “A robot arm with a universal sense of touch. Aiming to produce robots that live with humans”, Takashi Suehiro, Task Intelligence Research Group of Intelligent Systems Research Institute (Page 11). That article is about:
1. “Development of whole-body type tactile sensor. The whole-body typo tactile sensor we have developed here allows the exploration of variable resistance occurring at each cross point on a pattern that is printed horizontally and longitudinally using inductive pressure sensitive ink. The pattern detects the force exerted at each contact point. We have developed a robot forearm with seven degrees of freedom covered with 72 areas of tactile sensing detection capability (see Photo 2). A tactile force rendered at every area can then be detected and measured.”
2. ““Dodging” movement implemented to avoid danger. An excellent example of whole-body tactile sensing using this system is that. We implemented a dodging movement to avoiding touched. Making a motion in the opposite direction—away from each point where a touch is detected—the entire robot arm flinched, as if it were avoiding the touch.”

An article is “Measuring brain sensation and recognition of odors Robots and TVs sensing odors expected in the near future”, Mitsuo Tonoike, Living Informatics Group of Human Science and Biomedical Group (Page 12). That article is about:
1. “Mechanism by which a human being senses odors. We have been involved in research lo elucidate how the sense of smell is perceived and have recognized when the smell stimulation is received. Odors ate received in the nose, which is the olfactory organ.”
2. “Indirect measurement of odor sensation. In this study, we specifically recognized the central part of the brain (frontal eye field) that is activated when an odor is perceived. Furthermore, as shown in the diagram, we found that the perceived odor information was subsequently sent to another part of the brain (called the association cortex) within a tens of milliseconds to hundreds of milliseconds time frame after odor perception. Lastly, the odor is recognized in another part of the brain (upper lobe).”
3. “Future of information systems using odors. Once we clarify how information on odors is processed in the brain, we will become able to “give odors” or “receive odors” easily in any way desired.”

An article is “New information transmission using a colored illumination equipment”, Shigeharu Tamura, Photonics Research Institute (Page 13). That article is about:
1. “Information and benefits of illumination. For the basic technology of sense information communication, it is important not only to understand what impact a stimulus gives to humans, but also to establish a technology to produce stimuli to give to humans.”

An article is “Capturing “colors” Development of a neural circuit producing colors”, Yoichi Sugita, Cognitive and Behavioral Sciences Group of Neuroscience Research Institute (Pages 14, 15). That article is about:
1. “Neural mechanism to capture “colors”. Even if wavelength components of light radiation vary largely, humans are able to recognize objects' colors correctly.”
2. “Thus even if the characteristics of light coming into our eyes change to a great degree, we retain “color consistency,” by which we can recognize the color of an object correctly. That fact indicates that the light itself that comes into our eyes does not include “color” information.”
3. “Experiment on monkeys' “sense of color”. We raised a monkey from birth until it became one year old, allowing it only the monochromatic illumination that we provided so that it was unable to recognize any color. During that time, however, we changed the wavelength of the monochromatic light to red, green and blue alternately every minute, so that all three kinds of color acceptance cells (visual cortex) in the retina became active . . . ”

An article is “Seeing “taste” in the brain”, Professor Takashi Yamamoto, Graduate School of Human Sense Research at Osaka University (Page 14). That article is about:
1. “The research in which rum tasting is understood as part of brain function is underway. As a simple experiment, we tend to use sweet and good-tasting sugar solution or bitter and bad-tasting quinine solution. In the primary gustatory area (the area from the frontal operculum to insula). which recognizes taste, every different part is activated depending on the quality of the taste given. The amygdala and the anterior orbitofrontal cortex become strongly activated when a person tastes something delicious, the posterior orbitofrontal cortex and the anterior cingulate gyrus get strongly activated when a person tastes something bad-tasting.”
2. “Once the cerebral mechanism becomes better clarified in terms of identification of taste quality, and emotion of good tasting or bad tasting, the true objective evaluation on tasting would be put into effect so that it would he expected to help apply it for development of much better tasting food.”

The field of those articles is not an Artificial Intelligence of a cyborg or an android. The theme of those articles is not a computer system of an Artificial Intelligence of a cyborg or an android. The principal topics of those articles are not a received signal-reaction of the computer system of the Artificial Intelligence of the cyborg or the android, a corresponding association of the computer system of the Artificial Intelligence of the cyborg or the android, and a corresponding thought of the computer system of the Artificial Intelligence of the cyborg or the android.

From the U.S. Pat. No. 8,079,953, Prior Publication Data US 20060089541 A1, Publication Date Apr. 27, 2006, Inventors: Braun; Jeffrey C. (Ann Arbor, Mich.), Jacobus; Charles J. (Ann Arbor, Mich.), Booth; Scott (Ann Arbor, Mich.), Suarez; Michael (Ypsilanti, Mich.), Smith; Derek (Ann Arbor, Mich.), Hartnagle; Jeff (Ann Arbor, Mich.), Leprell; Glenn (Ypsilanti, Mich.) General-purpose medical instrumentation is known. This Patent is about:
1. “A general-purpose data routing and encapsulation architecture supports input tagging and standarized routing through modern packet switch networks, including the Internet; from one of multiple points of origin or patients, to one or multiple points of data analysis for physician review.”
2. The “medical instrumentation” includes, for example, “a single portable/wearable” medical “device”, “a programmable amplifier” or rather “a physical layout of one programmable amplifier board”, “a distributed power supply”, “a mother board and daughter cards”, “a front display and switch panel” etc.
3. “As indicated previously, functions can be attached through the Data Interface Library, to any DCE node. Some of these functions are pre-compiled code (typically C or C++, but alternatively any other language which can support a C, C++ linkage). In Win 32 systems, precompiled functions are in the form of executables or DLLs.”
4. “ . . . all data access functions are encapsulated within the Data Interchange Library. However, the GUI management functions associated with views are Unix or Win 32 platform dependent (X-based viewers can be executed on Win 32 platforms with an X-terminal task).”
5. “ . . . a plurality of data-collection environment (DCE) nodes into a hierarchical communications network architecture, each DCE node being operative to tag received physiologic data with time and source identifiers regarding the patient . . . ”

The field of the U.S. Pat. No. 8,079,953 is not an Artificial Intelligence of a cyborg or an android. The theme of the patent is not a computer system of an Artificial Intelligence of a cyborg or an android. The principal topics of the patent are not a received signal-reaction of the computer system of the Artificial Intelligence of the cyborg or the android, a corresponding association of the computer system of the Artificial Intelligence of the cyborg or the android, and a corresponding thought of the computer system of the Artificial Intelligence of the cyborg or the android.

With only know-how of the American patent (U.S. Pat. No. 6,341,372) and of the American patent (U.S. Pat. No. 7,171,352) and also with American patent (U.S. Pat. No. 7,333,967) nobody can realize the received signal-reaction of the computer system of the artificial intelligence of the cyborg or the android, the corresponding association of the computer system of the artificial intelligence of the cyborg or the android, and the corresponding thought of the computer system of the artificial intelligence of the cyborg or the android, consequently the computer system, in which the received signal-reaction of the computer system of the artificial intelligence of the cyborg or the android, the association of the computer system of the artificial intelligence of the cyborg or the android, the thought of the computer system of the artificial intelligence of the cyborg or the android are physically substantiated. (Only a word or only a semantic utterance or only a sentence are not the received signal-reaction of the computer system of the artificial intelligence of the cyborg or the android or the corresponding association of the computer system of the artificial intelligence of the cyborg or the android or the corresponding thought of the computer system of the artificial intelligence of the cyborg or the android.)

Besides for example, the substance of the thought of the computer system of the artificial intelligence of the cyborg or the android, which points to the words of the vocabulary of the computer system of the artificial intelligence of the cyborg or the android, and, the substance of the signal-reaction of the computer system of the artificial intelligence of the cyborg or the android, which points to all reactions of all sensors of all sensor groups of all sense organs of all senses, need to be referenced and synchronized. In the current invention, it is solved by means of the substance of the association of the computer system of the artificial intelligence of the cyborg or the android. From my patent applications or my patents “Pointer-oriented object acquisition method for abstract treatment of information of the computer system of artificial intelligence of a cyborg or an android based on one natural language”, for example my patent application (DE 10 2006 052 141 A1), my patent of the United States of America (U.S. Pat. No. 7,672,922 B2), my patent of the State of Israel (Pat. No. IL 182773): “The third pointer does not refer to the associative object of computer system. It is the task of the cyborg-interpreter both of these pointers, the third and the second, to reference and to synchronize. The cyborg-interpreter is working in the one natural language, for example German or English. Therefore, the reference of the abstract object, i.e. of the third pointer, get no access to the associative object, i.e. to the second pointer, i.e. even with help of the cyborg-interpreter.”

From my patent of the United States of America (U.S. Pat. No. 7,672,922 B2), my patent of the State of Israel (Pat. No. IL 182773), and the German patent application (DE 10 2008 019 877.3), a pointer-oriented object acquisition method for abstract treatment of information of the computer system of artificial intelligence of a cyborg or an android is known. That pointer-oriented object acquisition method for abstract treatment of information of the computer system of artificial intelligence of a cyborg or an android is based on one natural language. Those patents are about, that, in the case of the pointer-oriented object acquisition method for abstract treatment of information of the computer system of artificial intelligence of a cyborg or an android which is based on one natural language, three pointers are created in the computer main memory (in RAM (Random Access Memory)) of the computer system of artificial intelligence of a cyborg or an android in the natural language, in which the computer system is working at this timeframe, at run-time, in a way of the thinking paradigm of the class-based model of OOP, or rather of the programming language C++, as in instantiating an object on the Heap (the freely available memory storage area by dynamic memory allocation). In this way, the subjective object, the associative object, and the abstract object of the computer system of artificial intelligence of a cyborg or an android are instantiated and initialized. With those objects, which are implemented in the one natural language, one can access to, i.e. manipulate with the element variables, i.e. with the data elements, of a class of the classification tree of the computer system of artificial intelligence of a cyborg or an android. With the subjective object, or rather with the first pointer, a received signal-reaction is physically substantiated in the computer system of artificial intelligence of the cyborg or the android, in the sense of building a substance of the signal-reaction. With the associative object, or rather with the second pointer, an association is physically substantiated in the computer system of artificial intelligence of the cyborg or the android, in the sense of building a substance of the association. With the abstract object, or rather with the third pointer, a thought is physically substantiated in the computer system of artificial intelligence of the cyborg or the android, in the sense of building a substance of the thought.

From my patent of the United States of America (U.S. Pat. No. 8,271,411), my patent of the State of Israel (Pat. No. IL 175533), and the German patent application (DE 10 2014 000 086.9), a working method for treatment of abstract objects (the thought substances) of a computer system of artificial intelligence of a cyborg or an android is known. Those patents are about a working method for the treatment of the abstract objects (the thought substances) of the computer system of the artificial intelligence of the cyborg or the android, wherein the working method is based on one natural language and wherein internal directives of an abstract subjectivity of the computer system are used in the working method. The working method is impelled by the computer system of the artificial intelligence of the cyborg or the android by itself. In the working method, the abstract objects and/or the classes of the abstract objects are processed by the computer system of the artificial intelligence of the cyborg or the android in a nonpermanent, in the sense of a noncontinuous treatment mode, that means discretely, for each abstract object or rather the class of the abstract object. The decision, whether an abstract object is to be handled and how the abstract object is to be handled within the bounds of the determined treatment mode, is determined with the classification tree of the computer system of the artificial intelligence of the cyborg or the android. The treatment mode is determined with a function polymorphy of the computer system of the artificial intelligence of the cyborg or the android or rather the treatment mode can directly be designated. The abstract objects and the classes of the abstract objects are classified by the of the computer system of the artificial intelligence of the cyborg or the android by itself, subjectively, and in the one natural language. With the working method more than ten internal directives of the abstract subjectivity of the computer system can be used.

Please take into consideration, if a cyborg or an android heard the rule “If that and that is the case, then that and that is the case”, then the following would happen.

First of all, the words would be summarized with the appropriate signal-reactions under a signal-reactions substance (a subjective object):

If that and that is the case, then that and that is the case.see;

If that and that is the case, then that and that is the case.hear;

If that and that is the case, then that and that is the case.smell;

If that and that is the case, then that and that is the case.taste;

If that and that is the case, then that and that is the case.touch;

. . .

If that and that is the case, then that and that is the case.n-sense.

Secondly, an association substance (an associative object) would be created to the signal-reactions substance, that means, the association substance to the corresponding signal-reactions substance.

Thirdly, a thought substance (an abstract object) would be created to the association substance, that means, the thought substance to the corresponding association substance. In this example two thought substances (“is” and “is”) of the class “Be” would be created. The thought substances would be compared with the other thought substances . . . . (The thought substances would not be the “is” and “is”, but rather the “be” and “be”, because “If that and that does be the case, then that and that does be the case” would be understood . . . )

The article “Interfacing Silicon Nanowires with Mammalian Cells”, Woong Kim, Jennifer K. Ng, Miki E. Kunitake, Bruce R. Conklin, Peidong Yang, ACS PUBLICATIONS, Journal of the American Chemical Society (JACS), Published on Web: May 22, 2007, pp 7228-7229, is relevant to the state of the related art. This article is about an example of the interface from a computer system of artificial intelligence to a human body.
1. “We present the first demonstration of a direct interface of silicon nanowires with mammalian cells such as mouse embryonic stem (mES) cells and human embryonic kidney (HEK 293T) cells without any external force. The cells were cultured on a silicon (Si) substrate with a vertically aligned SiNW array on it. The penetration of the SiNW array into individual cells naturally occurred during the incubation. The cells survived up to several days on the nanowire substrates. The longevity of the cells was highly dependent on the diameter of SiNWs.

Furthermore, successful maintenance of cardiac myocytes derived from mES cells on the wire array substrates was observed, and gene delivery using the SiNW array was demonstrated. Our results suggest that the nanowires can be potentially utilized as a powerful tool for studying intra- and intercellular biological processes.”

The project “BBCI—An interface between brain and computer” is relevant to the state of the related art. “Project directors: Prof. Dr. Klaus-Robert Müller, Prof. Dr. Gabriel Curio, Dr. Benjamin Blankertz.”
1. “For several years, research groups in Europe and the USA have been working on systems which allow for a direct dialog between man and machine. To this end, a “Brain Computer Interface” (BCI) has been developed. Cerebral electric activity is recorded via the electroencephalogram (EEG): electrodes, attached to the scalp, measure the electric signals of the brain. These signals are amplified and transmitted to the computer, which transforms them into device control commands. The crucial requirement for the successful functioning of the BCI is that the electric activity on the scalp surface already reflects motor intentions, i.e., the neural correlate of preparation for hand or foot movements. The BCI detects the motor-related EEG changes and uses this information, for example, to perform a choice between two alternatives: the detection of the preparation to move the left hand leads to the choice of the first, whereas the right hand intention would lead to the second alternative. By this means it is possible to operate devices which are connected to the computer; such a communication can even be realised via the internet.”
2. “The project (BMBF Förderzeichen 01KO0121, 01IBB02A/B, 01IBE01A/B), which is supported by the ministry for education and research (Bundesministerium für Bildung and Forschung, BMBF), comprises the development of EEG-driven systems for computer-aided working environments. These systems will, for instance, allow for the control of a mouse pointer by means of brain waves. Furthermore, medical tools are being created for patients suffering from amyotrophia or quadriplegia.”
3. “This research program is done in a cooperation between the Berlin Institute of Technology, Machine Learning Laboratory (Prof. Dr. Klaus-Robert Müller and Dr. Benjamin Blankertz), Fraunhofer FIRST institute, research group IDA (Intelligent Data Analysis) (Prof. Dr. Klaus-Robert Müller and Dr. Benjamin Blankertz), and the neurophysics research group, Department of Neurology at Campus Benjamin Franklin, Charité—University Medicine, Berlin, (Prof. Dr. Gabriel Curio).”

The “BrainGate™ Neural Interface System”, a product of Cyberkinetics, Inc. is relevant to the state of the related art. The interface was described, for example, in article “Industry Shorts—Nexus: Cyberkinetics Initiates Pilot Study of BrainGate Neural Interface System”, Robotics Trends, Robots and Robotics Technology News, Information and Analysis, Published on Web: Wednesday, Apr. 21, 2004-07:23 PM, Copyright 2004 Business Wire, Inc.; Copyright® 2002 LexisNexis, a division of Reed Elsevier Inc.
1. “FOXBOROUGH, Mass., Apr. 20, 2004—Cyberkinetics, Inc. today announced that it has initiated a pilot study of the investigational BrainGate™ Neural Interface System.”
2. “About the BrainGate™ System:
Cyberkinetics' BrainGate Neural Interface System is a proprietary, investigational brain-computer interface device that consists of an internal neural signal sensor and external processors that convert neural signals into an output signal under the person's own control. The sensor consists of a tiny chip about the size of a baby aspirin, with one hundred electrode sensors each thinner than a hair that detect brain cell electrical activity. The sensor will be implanted on the surface of the area of the brain responsible for movement, the primary motor cortex. The sensor will be connected by a small wire to a pedestal which will be mounted on the skull, extending through the scalp. The pedestal will be connected by a cable to a cart containing several computers and monitor which will enable the study operators to determine how well a patient can control their neural output.”
3. “About Cyberkinetics, Inc.
Cyberkinetics is a leader in neurotechnology, an emerging field driven by advances in neuroscience, computer science, and engineering that promises to revolutionize the medical treatment of nervous system dysfunction. Cyberkinetics' first product, BrainGate™, is designed to give severely paralyzed patients a long-term, direct brain-computer interface for the purpose of communication and control of a computer. Cyberkinetics' intellectual property features key technologies licensed from Brown University, the Massachusetts Institute of Technology, Emory University, and the University of Utah. Cyberkinetics is headquartered in Foxborough, Mass. and conducts engineering and research in Salt Lake City, Utah.”

The three interfaces are some examples of the interfaces of the computer system of artificial intelligence to the human body, or rather to the cyborg body. That means that the computer system of artificial intelligence becomes the computer system of artificial intelligence of a cyborg with one of these interfaces.

Further, the humanoid robots are known which can move in human or animal way.

For example, ASIMO is a robot developed by company Honda which can move in human way.

The AIBO of company Sony, a robot-dog, which can be programmed. In addition, he can run, see, show his feelings and speak the predefined words.

The ORIO of company Sony. It is a humanoid robot itself, which can move in human way. He can do everything that the AIBO can do. He can also speak about something, or have a conversation. Besides, the speech recognition is used and the predefined response scenarios with many thousands of words are prepared. In addition, the ORIO is very expensive.

Further, the predicate logic is worldwide known. It plays a big role in informatics for the programming of expert's systems and artificial intelligence. It is based on the logical predicate, which can take part as either a property or a relation between entities, but not as an action. The predicate is considered as not object-oriented. Neither the subject term nor the predicate term is considered relative to time.

Some terms need to be defined for describing the present invention. The terms and their definitions include:
1. Android:
1.1. “Android der, -en/-en, Androide der, -n/-n ein zu bestimmten Tätigkeiten fähiger→Automat in Menschengestalt” (An android is→an automatic machine which is capable to the determined activities in the human shape) (The encyclopedia “Brockhaus-Enzyklopädie”: in 24 vol.—19., fully revised Edition, F. A. Brockhaus GmbH, Mannheim 1986, ISBN 3-7653-1101-4/3-7653-1201-0; page 562).
1.2. “An android is an artificially created robot, an automation, that resembles a human being . . . in . . . behavior. The word derives from the Greek andr-, “meaning “man, male”, and the suffix -eides, used to mean “of the species alike” (from eidos “species”).”—Wikipedia, the free encyclopedia. htm (http://en.wikipedia.org/wiki/Android);
1.2.1. Unlike the terms robot (a “mechanical” being) and cyborg (a being that is partly organic and partly mechanical), the word android has been used in literature and other media to denote several different kinds of artificially constructed beings:
1.2.1.1. a robot that closely resembles a human;
1.2.1.2. a cyborg that closely resembles a human;
1.2.1.3. an artificially created, yet primarily organic, being that closely resembles a human.
2. Cyborg:
2.1. “Cyborg [′saibo:g; Kw. aus engl. cybernetic organism >kybernetisches Lebewesen<] der, -s/-s, in der Futurologie Bez. für einen Menschen, in dessen Körper techn. Geräte als Ersatz zur Unterstützung nicht ausreichend leistungsfähiger Organe (z.B. für lange Raumflüge) integriert sind” (Cyborg [from engl. cybernetic organism] in futurology a term for a human being in whose body some technical devices are integrated as substitution for support of the insufficiently efficient organs (for example for long space-flights)) (The encyclopedia “Brockhaus-Enzyklopädie”: in 24 vol.—19., fully revised Edition, F. A. Brockhaus GmbH, Mannheim 1988, ISBN 3-7653-1105-7/3-7653-1205-3; page 67).
2.2. “The term cyborg, a portmanteau of cybernetic organism, is used to designate an organism which is a mixture of organic and mechanical (synthetic) parts . . . ”—Wikipedia, the free encyclopedia.htm (http://en.wikipedia.org/wiki/Cyborg);
2.2.1. Generally, the aim is to add to or enhance the abilities of an organism by using technology, i.e. a man-machine mixture;
2.2.2. “Isaac Asimov's short story “The Bicentennial Man” explored cybernetic concepts . . . . His explorations lead to breakthroughs in human medicine via artificial organs and prosthetics.” As well as to the “ . . . artificial positronic brain . . . ”;
2.2.3. “The term “cyborg” is used to refer to a man or woman with bionic, or robotic, implants.”
3. Strong artificial intelligence:
3.1. In the philosophy of artificial intelligence, strong artificial intelligence is the claim that some forms of artificial intelligence can truly reason and solve problems; strong artificial intelligence states that it is possible for machines to becomes sapient, or self-aware, but may or may not exhibit human-like thought processes.—Wikipedia, the free encyclopedia.htm (http://en.wikipedia.org/wiki/strong_AI);
3.2. “according to strong AI, the computer is not merely a tool in the study of the mind; rather, the appropriately programmed computer really is a mind” (J. Searle in Minds, Brains and Programs. The Behavioral and Brain Sciences, vol. 3, 1980).”—Wikipedia, the free encyclopedia.htm (http://en.wikipedia.org/wiki/strong_AI);
4. “The mind is the term most commonly used to describe the higher functions of the human brain . . . ”—Wikipedia, the free encyclopedia.htm (http://en.wikipedia.org/wiki/Mind).
5. In psychology . . . two concepts or stimuli are associated when the experience of one leads to the effects of another, due to repeated pairing. This is sometimes called Pavlovian association for Ivan Pavlov's pioneering of classical conditioning.—Wikipedia, the free encyclopedia.htm (http://en.wikipedia.org/wiki/Association_%28psychology%29).
6. Thought:
6.1. “Gedanke, in der Regel durch Sprache vermitteltes Ergebnis eines Aktes oder einer (mehr oder minder komplexen) Folge von Akten des Denkens und als solches wieder Gegenstand neuer G.ngänge.” ((Thought, as a rule, result (imparted with a language) of an act or a (more or less complex) sequence of the acts of thinking and as that again an object of new thought steps)) (Meyers Enzyklopädisches Lexikon in 25 Bd., Band 9: Fj-Gel, Mit Sonderbeiträgen von Hermann J. Abs, Ossip K. Flechtheim, Katharina Focke, Manfred Riedel, Bibliographisches Institut AG, Mannheim 1973, Lexikonverlag; Seite 787).
6.2. ““Ge|dan|ke [g [symbol] ′daηk [symbol] ], der; -ns, -n: etwas, was gedacht wird; . . . ” (Thought: something that is thought; . . . ) (Duden, Das Bedeutungswörterbuch, 4., neu bearbeitete und erweiterte Auflage, Duden Band 10, Bibliographisches Institut GmbH, Dudenverlag, Mannheim—Zürich, Duden 2010, ISBN 978-3-411-04104-6; Seite 412).
6.3. “The thought is a direct sense shape of thinking . . . the thought describes a result, a product of the thinking-process.”—Wikipedia, the free encyclopedia.htm (http://de.wikipedia.org/wiki/Gedanke).
6.4. “It (thought) is an element/instance of thinking and is used as its synonym.” “In philosophy, thought is also a synonym for idea.”—Wikipedia, the free encyclopedia.htm (http://en.wikipedia.org/wiki/Thought_(disambiguation)).
7. Abstract thinking:
7.1. “abstraktes Denken, Denkprozess, durch den sich losgelost (abstrahiert) von komplexen Sachverhalten bestimmte Aspekte verallgemeinern lassen” (abstract thinking, thinking process, with which the particular aspects unbound (abstracted) from the complex facts can be generalized) (The lexicon “Lexikon der Psychologie”: in 5 vol, editor: Gerd Wenninger—Heidelberg; Berlin: Spektrum, Akademischer Verlag GmbH, Heidelberg 2000, vol. 1. A to E, ISBN 3-8274-0312-X; page 9).
7.2. “Abstraktion die, -/-en, Denkvorgang bei der Bildung von Begriffen und Gesetzen, gekennzeichnet durch das stufenweise Heraussondern bestimmter Merkmale in der Absicht, das Gleichgebliebene und Wesentliche versch. Gegenstände zu erkennen; auch das Ergebnis des A.-Prozesses. Bei der generalisierenden A. werden die relevanten gemeinsamen Merkmale versch. Gegenstände oder Klassen herausgehoben, wobei von den unwesentlichen, sich unterscheidenden abgesehen wird” (Abstraction, thinking process, characterized by gradual separating particular attributes, during the definition of terms and laws, with intent to identify the unchanged and significant of particular objects; also the result of the A.-process. With the generalized A., the relevant general attributes of particular objects or classes are selected, and the irrelevant different attributes are irrespective.) (The encyclopedia “Brockhaus-Enzyklopädie”: in 24 vol.—20., fully revised Edition, F. A. Brockhaus GmbH, Mannheim 1996, vol. 1. A-AP, ISBN 3-7653-3100-7/3-7653-3101-5; page 84).
7.3. “Abstraktion, auf zufällige Einzelheiten verzichtende, begrifflich zusammengefaRte Darstellung; Vorgang und Ergebnis des Auswählens eines ganz bestimmten Aspekts eines komplexen Sachverhaltes, um diesen zu klassifizieren, zu bewerten und zu verallgemeinern” (Abstraction, conceptually generalized definition, abstaining from irrelevant details; process and result of selection of a quite particular aspect of a complex fact, in order to classify, to estimate and to generalize) (The lexicon “Lexikon der Psychologie”: in 5 vol, editor: Gerd Wenninger—Heidelberg; Berlin: Spektrum, Akademischer Verlag GmbH, Heidelberg 2000, vol. 1. A to E, ISBN 3-8274-0312-X; page 9).
7.4. “Abstraction is the process or result of generalization by reducing the information content of a concept or an observable phenomenon, typically in order to retain only information which is relevant for a particular purpose. For example, abstracting a leather soccer ball to a ball retains only the information on general ball attributes and behaviour.”—Wikipedia, the free encyclopedia.htm (http://en.wikipedia.org/wiki/Abstract_thinking).
8. Capacity for abstract thought:
8.1. “Abstraktionsvermögen→ . . . : das; -s; -(geistige) Fähigkeit, aus dem Besonderen etw. Allgemeines abzuleiten” ((intellectual) ability to derive something general from the particular) (The dictionary “Deutsches Worter-Buch”; Karl-Dieter Bünting, Isis Verlag AG, 1996, Chur/Schweiz, page 38).
9. Telepathy:
9.1. “Telepathy (from the Greek τ\tilde{η}λε, tele, “distant”; and π\acute{α}θεια, patheia, “feeling”) is defined in parapsychology as the paranormal acquisition of information concerning the thoughts, feelings or activity of another person.”—Wikipedia, the free encyclopedia.htm (http://en.wikipedia.org/wiki/Telepathy).
9.2. “The German Term for Telepathy is the Thoughts-Transfer.”—Wikipedia, the free encyclopedia (http://de.wikipedia.org/wiki/Telepathie).
10. “The most popular and developed model of OOP is a class-based model, as opposed to an object-based model. In this model, objects are entities that combine state (i.e., data), behavior (i.e., procedures, or methods) and identity (unique existence among all other objects). The structure and behavior of an object are defined by a class, which is a definition, or blueprint, of all objects of a specific type . . . ”—Wikipedia, the free encyclopedia.htm (http://en.wikipedia.org/wiki/Class-based_OOP).
11. Pointer:
11.1. “A pointer identifies in computer science a special class of variables, that refer to another memory space or the variables itself . . . . The referred memory space contains either data (object, variable) or the program code.”—Wikipedia, the free encyclopedia.htm (http://de.wikipedia.org/wiki/Zeiger).
11.2. In C and C++, pointers are variables that store addresses (of the computer memory) and can be NULL. A NULL-Pointer has a reserved value, often but not necessarily the value zero, indicating that it refers to no object. (The NULL-Pointer stores the address of a NULL-Object, i.e. points to nothing). A pointer is a simple implementation of the general reference data type (although it is quite different from the facility referred to as a reference in C++).—Wikipedia, the free encyclopedia.htm (http://en.wikipedia.org/wiki/Pointer).
11.3. “Ein Zeiger ist eine Variable, die eine Speicheradresse enthält.”
   “Die folgenden drei Dinge muß man sicher auseinanderhalten können, um Probleme mit Zeigern zu vermeiden:
   den Zeiger selbst,
   die im Zeiger gespeicherte Adresse,
   den Wert an der im Zeiger gespeicherten Adresse.”
(“A pointer is a variable that holds a memory address.”
   “It is important to distinguish between a pointer,”
   the pointer itself,
   “the address that the pointer holds, and
   the value at the address held by the pointer.”)
   (das Buch “C++ in 21 Tagen”, Jesse Liberty, 2000 by Markt & Technik Verlag, ISBN 3-8272-5624-0, die Autorisierte Übersetzung der amerikanischen Originalausgabe: “Teach Yourself C++ in 21 Days” © 1999 by SAMS Publishing; Seiten 252, 257).
12. Reference:
12.1. “A reference represents an identification of an object . . . . Therewith, a reference represents an alias name to an entity.”—Wikipedia, the free encyclopedia.htm (http://de.wikipedia.org/wiki/Referenz_%28Programmierung%29).
12.2. A reference is an alias-name. When a reference has been created, it will be initialized with the name of another object, with the target. From this moment, the reference will be like an alternative name for the target, and everything that will be applied to the reference will, in fact, refer to the target. (The book “C++ in 21 Tagen”, Jesse Liberty, 2000 by Markt & Technik Verlag (Publishing), ISBN 3-8272-5624-0, the authorized translation of the American original edition: “Teach Yourself C++ in 21 Days” © 1999 by SAMS Publishing, page 290).
13. Object:
13.1. Therewith . . . the new objects are created on the heap (the freely available memory storage area by dynamic memory allocation). The . . . given back address (of the memory storage area) will be stored in the pointer. (The book “C++ in 21 Tagen”, Jesse Liberty, 2000 by Markt & Technik Verlag (Publishing), ISBN 3-8272-5624-0, the authorized translation of the American original edition: “Teach Yourself C++ in 21 Days” © 1999 by SAMS Publishing, pages 263, 264, 267, 285).
13.2. “Der Operator new erzeugt solche Objekte, und der Operator delete kann benutzt werden, um sie zu zerstören. Objekte, die durch new angelegt wurden, werden als >>im Freispeicher<< befindlich bezeichnet (und auch als >>Heap-Objekte<< oder >>im dynamischen Speicher angelegt<<)” (The operator “new” creates such objects, and the operator “delete” can be used to destroy them. The objects that were instantiated with “new” are defined as allocated >>in the freely available memory storage<< (as well as >>Heap-Objects<< or >>that are created by dynamic memory allocation<<)) (The book “Die C++-Programmiersprache”; 3. Edition; Bjarne Stroustrup (Der Erfinder von C++); Addison Wesley Longman Verlag (Publishing); 1998; ISBN 3-8273-1296-5; page 136; (the American original edition: “The C++-Programming Language”, Bjarne Stroustrup (The inventor of C++), Third Edition, Addison-Wesley, Reading, ISBN 0-201-88954-4 © 1997 AT&T)).
14. Database table as an array of pointers:
“Da das erstellte Formular der Beispielanwendung Informationen zu einer Person enthält, bietet es sich an, die neue Klasse CPerson zu nennen. Damit Sie die Klasse im Objektarray speichern können, müssen Sie die Klasse von CObject als Basisklasse ableiten.”
“Nach der gleichen Logik, . . . , nehmen Sie in der heutigen Beispielanwendung einen neuen Personendatensatz in das Objektarray der Dokumentklasse auf. Nachdem Sie einen neuen Datensatz hinzugefOgt haben, können Sie einen Zeiger darauf zurückgeben, so daß die Ansichtsklasse direkt die Variablen im Datensatzobjekt aktualisieren kann.”
“Sobald der neue Datensatz hinzugefügt ist, setzen Sie den aktuellen Datensatzzeiger auf den neuen Datensatz im Array. Auf diese Weise läßt sich die aktuelle Datensatznummer leicht anhand des Positionszählers bestimmen.”
“For your sample application, because the form that you created has information about a person, you might want to call your class something like CPerson. To be able to hold your class in the object array, you need to give it CObject as the base class.”
“Following the same logic . . . , you should add a new person record to the object array in your document class in today's sample application. Once you add a new record, you can return a pointer to the new record so that the view class can directly update the variables in the record object.”
“Once the new record is added, you will want to set the current record position marker to the new record in the array. This way, the current record number can be easily determined by checking the position counter.”
Visual C++ 6 in 21 Tagen, Davis Chapman, Deutsche Übersetzung: Frank Langenau, 1998 by SAMS, Markt & Technik Buch- and Software-Verlag GmbH, ISBN: 3-8272-2035-1, pages 325, 333; Sams Teach Yourself Visual C++ ® 6 in 21 Days, Copyright © 1998 by Sams Publishing, ISBN: 0-672-31240-9, pages 288, 295, 296).

### OBJECTIVES OF THE INVENTION

The way of posing a problem of this invention is to realize a computer system of an artificial intelligence of a cyborg or an android, wherein the computer system of the artificial intelligence of the cyborg or the android is based on one natural language, and wherein a received signal-reaction of the computer system of the artificial intelligence of the cyborg or the android, an association of the computer system of the artificial intelligence of the cyborg or the android, a thought of the computer system of the artificial intelligence of the cyborg or the android should be substantiated in this computer system of the artificial intelligence. The computer system should be with its working method:
dependent on no hardware;
dependent on no operating system;
dependent on no computer language;
dependent on no code;
dependent on no software;
dependent on no software developer, by software developing;
dependent on no software developer, as a person, who considers all things with own subjectivity;
dependent on no database or another way to store data;
dependent on no the specific computer language column types, for example, Integer, Number, Universal Unique Identifier, Global Unique Identifier, etc., for creating all primary keys of the database tables (in case of using one (or more) database(s)).

The computer system should be economical for the further development relative to both the hardware devices and the software components.

### BRIEF SUMMARY OF THE INVENTION

The innovative solution accomplished by the present invention is that the received signal-reaction of the computer system of the artificial intelligence of the cyborg or the android (a subjective object), the corresponding association of the computer system of the artificial intelligence of the cyborg or the android (an associative object), and the corresponding thought of the computer system of the artificial intelligence of the cyborg or the android (an abstract object) are substantiated in the computer system of the artificial intelligence of the cyborg or the android. Furthermore, the computer system uses with its working method one natural language. The one natural language, which the computer system uses with its working method, is interpreted by the computer system as object-oriented. The computer system functionality is based on these objects, two of which, the corresponding association of the computer system of the artificial intelligence of the cyborg or the android (an associative object) and the corresponding thought of the computer system of the artificial intelligence of the cyborg or the android (an abstract object), are defined relative to a time. The time has been obtained from the received signal-reaction of the computer system of the artificial intelligence of the cyborg or the android. The relativity to time has been defined in the one natural language. The computer system of the artificial intelligence of the cyborg or the android comprises at least five senses equipped with sense organs, wherein the senses are a sense of sight, a sense of hearing, a sense of smell, a sense of taste, and a sense of touch, and wherein the senses are built-in artificial parts of the artificial intelligence of the cyborg or the android. At least one sensor group is built in for each sense organ in order to implement the functionality of the sense organ. Each sensor group receives the reactions of the sensors of the sensor group and collects its. The sensor network of the artificial intelligence of the cyborg or the android summarizes all reactions of all sense organs of all senses to the received signal-reaction. The objects, the received signal-reaction of the computer system of the artificial intelligence of the cyborg or the android (a subjective object), the corresponding association of the computer system of the artificial intelligence of the cyborg or the android (an associative object), and the corresponding thought of the computer system of the artificial intelligence of the cyborg or the android (an abstract object) are classified by the computer system according to an action in the one natural language. These objects are no objects of a computer language. The computer system uses a reference in another natural language to the thought of the computer system of the artificial intelligence of the cyborg or the android (to the abstract object) in a first natural language for a working method in the other natural language. The computer system of the artificial intelligence of the cyborg or the android can act as an artificial brain of the cyborg.

In details, summarizing follows the subjective first input of the incoming signals of the sensors of the sensor groups by the computer system. At least five sensor groups of the sensor network of the computer system of the artificial intelligence of the cyborg or the android, at least one sensor group of the sense of sight, at least one sensor group of the sense of hearing, at least one sensor group of the sense of smell, at least one sensor group of the sense of taste, at least one sensor group of the sense of touch, receive the incoming signals, summarize the reactions of the sensors of each sensor group (or rather all reactions of all sensors of all sensor groups of one sense) to the particular incoming signals into sensor reactions to the particular signals, one sensor reaction to the particular signals from all sensor groups of one sense. With the appropriate input interfaces, the five sensor reactions to the particular signals, or rather the subjective reactions of the sensors of the sensor groups, come at the same time to the senses input receiver. The senses input receiver builds a subjective object that contains a combination of all sensor reactions to the particular signals. This combination of the sensor reactions to the particular signals is defined as a received signal-reaction of the computer system of the artificial intelligence of the cyborg or the android. With the subjective object, the received signal-reaction of the computer system of the artificial intelligence of the cyborg or the android is physically substantiated in the computer system, in the sense of building a substance of the received signal-reaction.

More precisely, this means that a subjective object is physically built, wherein the subjective object contains the combination of the sensor reactions to the particular signals.

As a matter of course, some sensor reactions to the particular signals have been initialized with NULL. However, the sensor reactions are also contained in the subjective object. The received signal-reaction of the computer system of the artificial intelligence of the cyborg or the android (the subjective object) is not handled relative to a time.

Then, the associative recognition of the received signal-reaction of the computer system of the artificial intelligence of the cyborg or the android by the computer system to a phrase of one natural language follows. The computer system analyzes the received signal-reaction in the one natural language with respect to other associations of the computer system of the artificial intelligence of the cyborg or the android. After processing by the cyborg-interpreter, this phrase is completed and it is provided with a time, wherein at least one corresponding association corresponds with at least one received signal-reaction, wherein the corresponding association corresponds with the received signal-reaction in the one natural language. The time has been obtained from the received signal-reaction of the computer system of the artificial intelligence of the cyborg or the android. The relativity to time has been defined in the one natural language. Associative collecting pursues goals that the associative object is completed in the one natural language, that it is defined relative to a time, and that it is uniquely stored for the long term, as well as that it can be found over and over again. A further combination of the received signal-reaction with this phrase builds an associative object of the computer system.

With the associative object, an association of the computer system of the artificial intelligence of the cyborg or the android is physically substantiated in the computer system, in the sense of building a substance of the association.

More precisely, this means that an associative object is physically built, wherein the associative object contains the further combination of the received signal-reaction with this phrase.

The phrase which contains the associative object is analytically and abstractly analyzed by the cyborg-interpreter during processing. This phrase is parsed on the single words with the analytical and abstract analyzing. Each parsed word is defined as a part of speech and/or as a part of a sentence. Then, each word of the phrase will be analyzed analytically and abstractly, with regard to the class classification, the polymorphism, the units of measurement, and the intonation. Then, each word of the phrase will be uniquely stored for the long term, classified according to an action in the one natural language, with an analytic entity, with having consideration for the word order of the phrase, relative to the time that has been obtained from the received signal-reaction of the computer system of the artificial intelligence of the cyborg or the android. The relativity to time has been defined in the one natural language. Such a phrase stored word by word represents an abstract object of the computer system. With the abstract object, a thought of the computer system of the artificial intelligence of the cyborg or the android is physically substantiated in the computer system, in the sense of building a substance of the thought.

More precisely, this means that an abstract object is physically built, wherein the abstract object contains the phrase stored word by word, wherein the abstract object is provided with at least one analytic entity, and wherein the word order of the phrase and the relativity to the time are taken into consideration in the abstract object.

The computer system operates with this abstract object during processing.

The decision, whether an abstract object is to be handled and how the abstract object is to be handled within the bounds of the determined treatment mode, is determined with the classification tree of the computer system of the artificial intelligence of the cyborg or the android. The treatment mode is determined with a function polymorphism of the computer system of the artificial intelligence of the cyborg or the android or rather the treatment mode can directly be designated. The abstract objects and the classes of the abstract objects are classified by the of the computer system of the artificial intelligence of the cyborg or the android by itself, subjectively, and in the one natural language.

The abstract object can be found by the computer system over and over again. The associative object will be found corresponding to the abstract object. The subjective object will be found corresponding to the associative object.

The subjective object can be returned.

The subjective object will be split according to all sensor groups of one sense into the sensor reactions to the particular signals for all sensor groups of one sense. Then on its return, the sensor reactions will be disassembled into the reactions of the sensors of the sensor group to the particular outcoming signal for output. The output mode, output value, and output unit of measurement will be defined for each output interface of the sensor groups.

The computer system uses one natural language for the working method. For the working method in the first, original, natural language, the computer system can use references in another natural language to words in the first, original, natural language. But the references, i.e. the abstract objects in another natural language, in another natural language to the abstract objects in the first, original, natural language, are used by the computer system during the working method in the other natural language. The same logic will be used for several natural languages.

The subjective object (the received signal-reaction), the associative object (the corresponding association), the abstract object (the corresponding thought) are physically substantiated as the appropriate pointers.

In general, a pointer is about a physical particular area of a computer memory, both the physical particular area of the computer memory where some data is allocated and the other physical particular area of the computer memory which points to the first one (the pointer in which the given back addresses of the computer memory are stored).

(I ask to be excused for the following such a primitive example.)

In the simplest case, this patent application is about a computer system and a working method of the computer system, wherein the computer system comprises, for example, total primitively, a computer memory module (a Random Access Memory (RAM) module), for example, a Kingston computer memory module KVR667D2N5/1G.

The subjective object (a substance of a combination of the sensor reactions to the particular signals) of the computer system of the artificial intelligence of a cyborg or an android is not the input of one sensor reaction to the particular signals or n sensor reactions to the particular signals from n sensor groups. The subjective object (the substance of the combination of the sensor reactions to the particular signals) of the computer system of the artificial intelligence of the cyborg or the android is a first pointer in which the given back RAM (Random Access Memory) addresses of the inputs of all sensor reactions to the particular signals from all sensor groups of at least five senses equipped with sense organs (or rather from all sensor groups of the sense of sight, all sensor groups of the sense of hearing, all sensor groups of the sense of smell, all sensor groups of the sense of taste, all sensor groups of the sense of touch, and thereto all sensor groups of all other senses that are equipped with sense organs) are stored. The first pointer is identified as a received signal-reaction of the computer system of the artificial intelligence of the cyborg or the android.

In other words, the first pointer stores at least five RAM addresses, or rather the first pointer points to at least five RAM addresses.

The associative object (a substance of the further combination of the received signal-reaction with a phrase) of the computer system of the artificial intelligence of the cyborg or the android is also a pointer in which the given back RAM (Random Access Memory) addresses are stored. That is that the subjective object, or rather the first pointer that is identified as the subjective object, after it has been completed associatively and relative to the time, will be stored in the Random Access Memory (RAM) of the computer system of the artificial intelligence of the cyborg or the android at run-time as a second pointer. With the second pointer the associative object (the substance of the further combination of the received signal-reaction with the phrase) will be built. The second pointer is identified as the corresponding association of the computer system of the artificial intelligence of the cyborg or the android.

In other words, the computer system of the artificial intelligence knows the at least five Random Access Memory (RAM) addresses of the subjective object only as one corresponding association.

The abstract object (a substance of a phrase stored word by word, wherein the abstract object is provided with at least one analytic entity, and wherein the word order of the phrase and the relativity to the time are taken into consideration in the abstract object) of the computer system of the artificial intelligence of the cyborg or the android is not a word or a semantic utterance or a sentence. The abstract object (the substance of the phrase stored word by word) of the computer system of the artificial intelligence of the cyborg or the android is a third pointer on the vocabulary of the computer system. The given back Random Access Memory (RAM) addresses of the computer memory area in which each word of the vocabulary of the computer system of the artificial intelligence of the cyborg or the android is mapped are stored in this third pointer. The third pointer is identified as the corresponding thought of the computer system of the artificial intelligence of the cyborg or the android.

In other words, the computer system of the artificial intelligence processes the at least five Random Access Memory (RAM) addresses of the subjective object only as the one corresponding association, wherein processing the one corresponding association takes place only in the one natural language by means of the corresponding thought.

The instant invention is protected by my patent of the State of Israel, Patent No.: IL 174910, “Computer system and the working method of this computer system of artificial intelligence of a cyborg or an android.” This invention as also my inventions “Pointer-oriented object acquisition method for abstract treatment of information of AI of a cyborg or an android based on a natural language” my patent of the United States of America, Patent No.: U.S. Pat. No. 7,672,922, my patent of the State of Israel, Patent No.: IL 182773, the German patent application, Patent Application No.: DE 10 2008 019 877.3, and “Working method for treatment of abstract objects (the thought substances) of the computer system of the artificial intelligence of a cyborg or an android”, my patent of the United States of America, U.S. Pat. No. 8,271,411, my patent of the State of Israel, Patent No.: IL 175533, the German patent application, Patent Application No.: DE 10 2014 000 086.9, is based on one of my scientific discoveries, and/or my theory of subjectivity, with the theme—“Human intelligence. Natural intelligence. The functionality of the human (natural) intelligence.”

The three inventions make it possible either the conversion of a humanoid robot into an android or the conversion of a human being into a cyborg with the artificial component, or with the artificial part,—the artificial intelligence.

An enormous gigantic job potential, which includes thousands of highly qualified, highly motivated, high-quality jobs in the different branches, is hidden behind this invention.

Except the use of the computer system and the working method as a computer system and a working method of this computer system of the artificial intelligence of a cyborg or an android, the invention is susceptible of industrial application, for example:
1. in the manufacture of toys. In this way, a doll can be produced with a computer system of the artificial intelligence. The doll will communicate with the child actively. It can be used for education purposes. It can be used for teaching methods. It can be used as a friend for children . . .
2. in the medicine. In this way, a model of the central nervous system of a mentally ill or neurological ill patient can be implemented. The model will be used in the illness simulations and for the simulations of healing methods;
3. in the fight against crime. In this way, a model of the central nervous system of a criminal can be implemented. His steps can be pre-estimated with the model;
4. for counterterrorism. In this way, a model of the central nervous system of a terrorist can be implemented. Thus, the behavior and manners of the terrorists can be pre-estimated. Thus, for example, the future terrorist attacks can be prevented.

Other details, features, and advantages result from the execution examples shown in the drawings, and from the independent and dependent claims. The execution examples follow the description.

### BRIEF DESCRIPTION OF THE DRAWINGS

In the drawings:

FIG. 1A shows the computer system of the artificial intelligence of the cyborg or the android.

FIG. 1B shows a detailed drawing of the hardware devices node of the sensor groups of the sense of sight and, for example, a detailed drawing of the hardware devices node of the sensor groups of the n-sense.

FIG. 2 illustrates the received signal-reaction of the computer system of the artificial intelligence of the cyborg or the android (the subjective object) and the working method for building the combination of the sensor reactions to the particular signals.

FIG. 3 illustrates the corresponding association of the computer system of the artificial intelligence of the cyborg or the android (the associative object) and the working methods for an associative recognition by the computer system of the artificial intelligence of the cyborg or the android and a cleanup of the corresponding associations of the computer system of the artificial intelligence of the cyborg or the android.

FIG. 4 illustrates the corresponding thought of the computer system of the artificial intelligence of the cyborg or the android (the abstract object) and the working methods for abstract analyzing of the corresponding association in one natural language, for transforming the corresponding association into a corresponding thought (the abstract object) of the computer system of the artificial intelligence of the cyborg or the android in the one natural language, for operating the corresponding thought, for storing the corresponding thought, and for finding the corresponding association again.

FIG. 5 illustrates splitting the subjective object according to all sensor groups of each sense into the sensor reactions and disassembling the sensor reactions into the reactions of the sensors for output, and the working method for returning the subjective object from the computer system.

FIG. 6 illustrates the working method of the computer system of the artificial intelligence of the cyborg or the android in another natural language or in several natural languages.

FIG. 7 shows some examples of the abstract objects that are generated in one natural language.

FIG. 8 shows some more examples of the abstract objects that are generated in one natural language.

FIG. 9 shows some more examples of the abstract objects that are generated in one natural language.

### DETAILED DESCRIPTION OF THE INVENTION

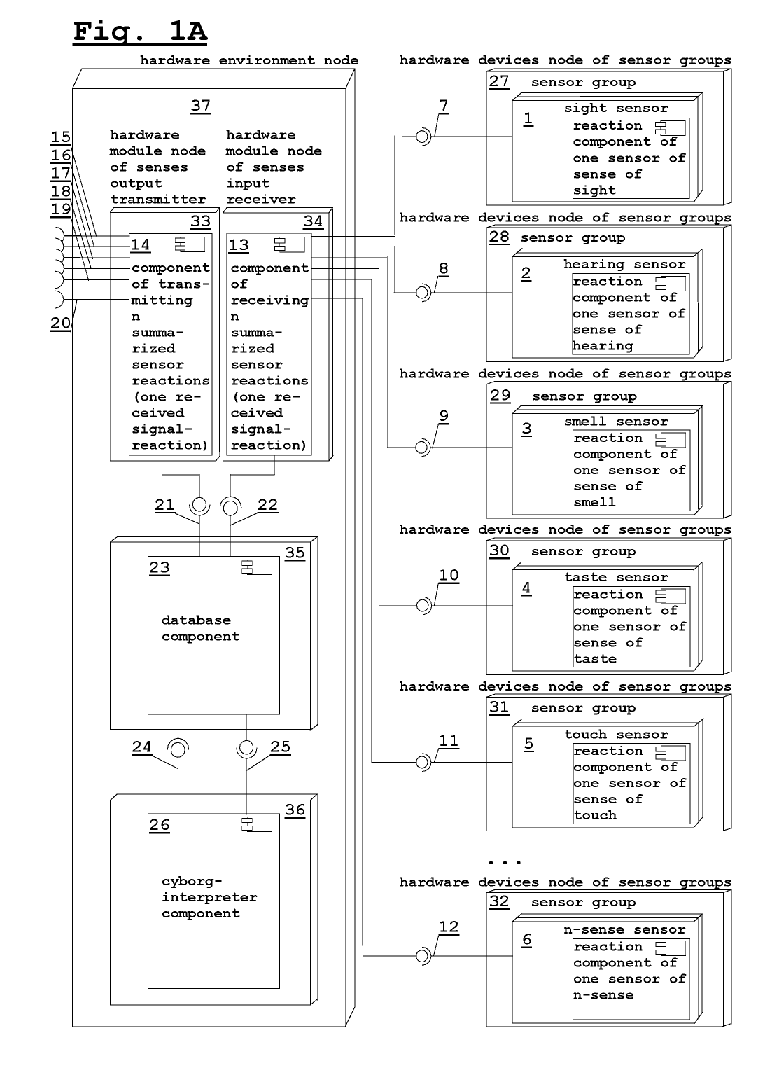

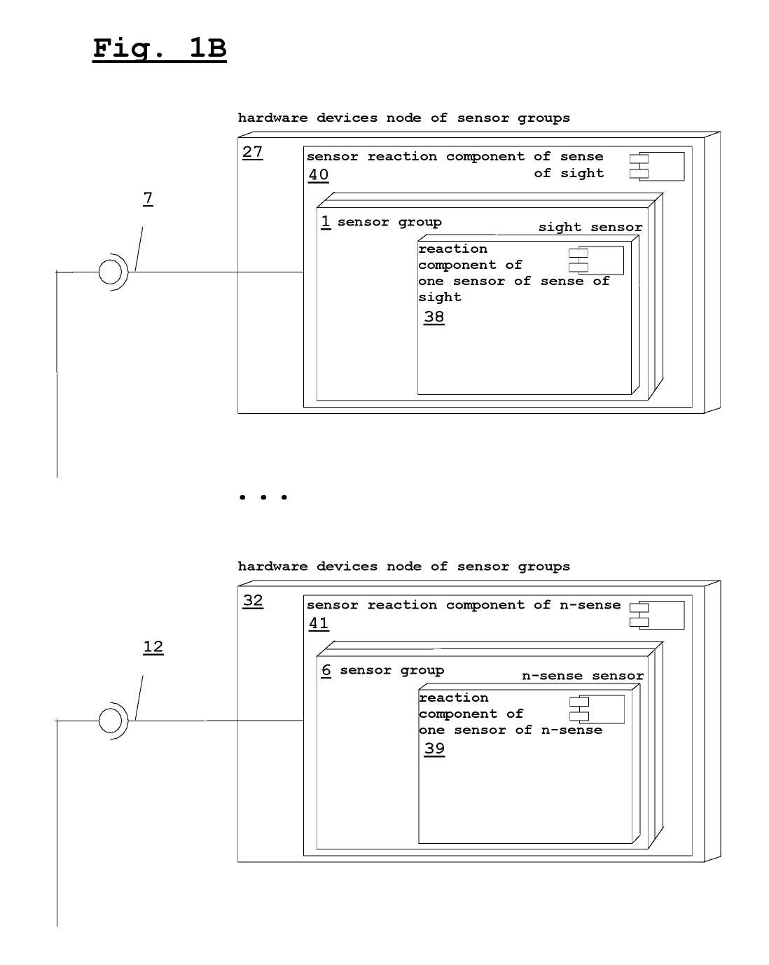

FIG. 1A shows the computer system of the artificial intelligence of the cyborg or the android. At least five sensor groups of the sensor network of the computer system of the artificial intelligence of the cyborg or the android, at least one sensor group of the sense of sight 1, at least one sensor group of the sense of hearing 2, at least one sensor group of the sense of smell 3, at least one sensor group of the sense of taste 4, and at least one sensor group of the sense of touch 5 receive the incoming signals, summarize the reactions of the sensors of each sensor group (or rather all reactions of all sensors of all sensor groups of one sense) to the particular incoming signals into sensor reactions to the particular signals, one sensor reaction to the particular signals from all sensor groups of one sense, i.e. one sensor reaction to the see signals from all sensor groups of the sense of sight, one sensor reaction to the hear signals from all sensor groups of the sense of hearing, one sensor reaction to the smell signals from all sensor groups of the sense of smell, one sensor reaction to the taste signals from all sensor groups of the sense of taste, and one sensor reaction to the touch signals from all sensor groups of the sense of touch, and forward the sensor reactions to the particular signals at the same time. With the appropriate input interfaces, the seeing input interface 7, the hearing input interface 8, the smelling input interface 9, the degusting input interface 10, and the touching input interface 11, the five sensor reactions to the particular signals come at the same time to the senses input receiver 34. The sixth sensor group realizes the sensor group of the n-sense 6, as well as the sixth input interface realizes the input interface of the n-sense 12. At least one sensor group of the n-sense and the input interface of the n-sense process the sensor reaction to the n-sense signals from all sensor groups of the n-sense. As a result, the subjective reactions of the sensors of the sensor groups come at the same time to the senses input receiver. The senses input receiver builds a subjective object that contains a combination of all sensor reactions to the particular signals from all sensor groups of all senses equipped with sense organs. The subjective object is then the received signal-reaction of the computer system of the artificial intelligence of the cyborg or the android.

The component of receiving n summarized sensor reactions (one received signal-reaction) 13 of FIG. 1A shows the received signal-reaction of the computer system of the artificial intelligence of the cyborg or the android after receiving the summarized sensor reactions with the senses input receiver.

In another implementation, first, the sensor network of the computer system of the artificial intelligence of the cyborg or the android forwards all reactions of all sensors of all sensor groups of at least five senses equipped with sense organs, wherein each sense organ is equipped with at least one sensor group, by means of the appropriate input interfaces to the senses input receiver. Second, the senses input receiver summarizes the reactions of the sensors of the sensor groups into the sensor reactions to the particular signals, wherein one sensor reaction to the particular signals summarizes all reactions of all sensors of all sensor groups of one sense which the particular signals belong to. More precisely, this means that one sensor reaction to the particular signals summarizes all reactions of all sensors of all sensor groups of one sense to the particular signals, wherein the particular signals belong to the one sense. Third, the senses input receiver builds a subjective object that contains a combination of all sensor reactions to the particular signals from all sensor groups of all senses equipped with sense organs.

The senses input receiver writes the subjective reactions of the sensors of the sensor groups, or rather the sensor reactions to the particular signals, with the database input interface 22 at the same time into the database 23. The cyborg-interpreter 26 accesses the data in the database by means of the interpreter input interface 24 and the interpreter output interface 25. The work results of the cyborg-interpreter are stored in the database. With the database output interface 21, with the senses output transmitter 33, and with the five output interfaces: the show output interface 15, the sound output interface 16, the scent output interface 17, the taste output interface 18, and the touch output interface 19, the sensor reactions to the particular signals, or rather the subjective reactions of the sensors of the sensor groups, are read at the same time from the outside. The sixth output interface realizes the output interface of the n-sense 20.

The component of transmitting n summarized sensor reactions (one received signal-reaction) 14 of FIG. 1A shows the received signal-reaction of the computer system of the artificial intelligence of the cyborg or the android before transmitting the summarized sensor reactions with the senses output transmitter.

The senses output transmitter provides for the output the subjective object split according to all sensor groups of one sense into the sensor reactions to the particular signals for all sensor groups of one sense. This means that the senses output transmitter provides for the output all sensor reactions to the particular signals for all sensor groups of all senses equipped with sense organs, i.e. one sensor reaction to the see signals for all sensor groups of the sense of sight, one sensor reaction to the hear signals for all sensor groups of the sense of hearing, one sensor reaction to the smell signals for all sensor groups of the sense of smell, one sensor reaction to the taste signals for all sensor groups of the sense of taste, and one sensor reaction to the touch signals for all sensor groups of the sense of touch, and transmits the sensor reactions to the particular signals at the same time. In the same way, the senses output transmitter provides for the output the sensor reaction to the n-sense signals for all sensor groups of the n-sense. The output mode, output value, and output unit of measurement will be defined for each output interface of the sensor groups.

By means of the five output interfaces: the show output interface 15, the sound output interface 16, the scent output interface 17, the taste output interface 18, and the touch output interface 19, the five sensor reactions to the particular signals are disassembled into the reactions of the sensors of each sensor group to the particular outcoming signal for output. The sixth output interface realizes the output interface of the n-sense 20. The sixth output interface disassembles the sensor reaction of the n-sense into the reactions of the sensors of each sensor group of the n-sense for output. (This means that, as a result, the subjective reactions of the sensors of the sensor groups are prepared to read at the same time from the outside.)

In another implementation, first, the senses output transmitter splits for the output the subjective object according to all sensor groups of one sense into the sensor reactions to the particular signals for all sensor groups of one sense, one sensor reaction to the particular signals for all sensor groups of one sense, i.e. one sensor reaction to the see signals for all sensor groups of the sense of sight, one sensor reaction to the hear signals for all sensor groups of the sense of hearing, one sensor reaction to the smell signals for all sensor groups of the sense of smell, one sensor reaction to the taste signals for all sensor groups of the sense of taste, and one sensor reaction to the touch signals for all sensor groups of the sense of touch. In the same way, the sensor reaction to the n-sense signals for all sensor groups of the n-sense is built. Second, the senses output transmitter disassembles the sensor reactions into the reactions of the sensors of each sensor group to the particular outcoming signal for output. The output mode, output value, and output unit of measurement will be defined for each output interface of the sensor groups. By means of the appropriate output interfaces, the reactions of the sensors of each sensor group to the particular outcoming signal are prepared to read at the same time from the outside.

The hardware devices nodes and hardware module nodes are illustrated under the numbers 27, 28, 29, 30, 31, 32, 33, 34, 35, and 36. They are implemented for the test and demo purposes as some different computers. The peripheral devices as well as the microcontrollers will be used for production. The internal hardware environment node is illustrated under the number 37.

In another implementation, the sensor reactions to the particular signals are stored with the senses input receiver on the hard disk into the signal data files and can be returned with the senses output transmitter. The names of the signal data files are written with the database input interface into the database and will be read with the database output interface from the database. In this case, the subjective object (the received signal-reaction of the computer system of the artificial intelligence of the cyborg or the android) that contains a combination of the sensor reactions to the particular signals is created from the names of the files. In this case also, all data is stored in the database only as a single data type, for example the character string. In this case, the computer system is independent of the database, or it needs a quite simple database.

The received signal-reaction of the computer system of the artificial intelligence of the cyborg or the android (a subjective object), the corresponding association of the computer system of the artificial intelligence of the cyborg or the android (an associative object), and the corresponding thought of the computer system of the artificial intelligence of the cyborg or the android (an abstract object) are substantiated in the computer system of the artificial intelligence of the cyborg or the android. (Substantiating of the subjective object, of the associative object, and of the abstract object is explained below at the end of the description of FIG. 1A in detail.) Furthermore, the computer system uses with its working method one natural language. The one natural language, which the computer system uses with its working method, is interpreted by the computer system as object-oriented. The computer system functionality is based on these objects, two of which, the corresponding association of the computer system of the artificial intelligence of the cyborg or the android (an associative object) and the corresponding thought of the computer system of the artificial intelligence of the cyborg or the android (an abstract object), are defined relative to a time. The time has been determined from the sensor reactions to the particular signals of the combination that has been contained in the subjective object, or rather from the reactions of the sensors of at least one sensor group to the particular incoming signals. This means that the time has been obtained from the received signal-reaction of the computer system of the artificial intelligence of the cyborg or the android. The relativity to time has been defined in the one natural language. The computer system of the artificial intelligence of the cyborg or the android comprises at least five senses equipped with sense organs, wherein the senses are a sense of sight, a sense of hearing, a sense of smell, a sense of taste, and a sense of touch, and wherein the senses are built-in artificial parts of the artificial intelligence of the cyborg or the android. At least one sensor group is built in for each sense organ in order to implement the functionality of the sense organ. Each sensor group receives the reactions of the sensors of the sensor group and collects its. The sensor network of the artificial intelligence of the cyborg or the android summarizes all reactions of all sense organs of all senses to the received signal-reaction. The objects, the received signal-reaction of the computer system of the artificial intelligence of the cyborg or the android (a subjective object), the corresponding association of the computer system of the artificial intelligence of the cyborg or the android (an associative object), and the corresponding thought of the computer system of the artificial intelligence of the cyborg or the android (an abstract object) are classified by the computer system according to an action in the one natural language. These objects are no objects of a computer language. The computer system uses a reference in another natural language to the thought of the computer system of the artificial intelligence of the cyborg or the android (to the abstract object) in a first natural language for a working method in the other natural language. The computer system of the artificial intelligence of the cyborg or the android can act as an artificial brain of the cyborg.

In details, summarizing follows the subjective first input of the incoming signals of the sensor groups by the computer system. First, all reactions of all sensors of all sensor groups of at least five senses equipped with sense organs, wherein each sense organ is equipped with at least one sensor group, are summarized into the sensor reactions to the particular signals, wherein one sensor reaction to the particular signals summarizes all reactions of all sensors of all sensor groups of one sense which the particular signals belong to. Second, the sensor reaction to the see signals from the sensor groups of the sense of sight, the sensor reaction to the hear signals from the sensor groups of the sense of hearing, the sensor reaction to the smell signals from the sensor groups of the sense of smell, the sensor reaction to the taste signals from the sensor groups of the sense of taste, and the sensor reaction to the touch signals from the sensor groups of the sense of touch are summarized to a combination of the sensor reactions to the particular signals. The summarizing is subjective. More precisely, this means that a combination of all sensor reactions to the particular signals from all sensor groups of all senses equipped with sense organs is built. This combination of the sensor reactions to the particular signals is defined as a received signal-reaction of the computer system of the artificial intelligence of the cyborg or the android (as a subjective object). With the subjective object, a received signal-reaction of the computer system of the artificial intelligence of the cyborg or the android is physically substantiated in the computer system, in the sense of building a substance of the signal-reaction.

More precisely, this means that a subjective object is physically built, wherein the subjective object contains the combination of the sensor reactions to the particular signals.

As a matter of course, some sensor reactions to the particular signals have been initialized with NULL. However, the sensor reactions are also contained in the subjective object. The received signal-reaction of the computer system of the artificial intelligence of the cyborg or the android (the subjective object) is not handled relative to a time.

Then, the associative recognition of the received signal-reaction of the computer system of the artificial intelligence of the cyborg or the android by the computer system to a phrase of one natural language follows. The computer system analyzes the received signal-reaction in the one natural language with respect to other associations of the computer system of the artificial intelligence of the cyborg or the android. After processing by the cyborg-interpreter, this phrase is completed and it is provided with a time, wherein the computer system completes the received signal-reaction in the one natural language relative to the time, wherein the computer system works in the one natural language, and the computer system completes the received signal-reaction in the one natural language associatively to the computer system of the artificial intelligence of the cyborg or the android, wherein the computer system works in the one natural language, wherein at least one corresponding association corresponds with at least one received signal-reaction, wherein the corresponding association corresponds with the received signal-reaction in the one natural language. The time has been determined from the sensor reactions to the particular signals of the combination that has been contained in the subjective object, or rather from the reactions of the sensors of at least one sensor group to the particular incoming signals. This means that the time has been obtained from the received signal-reaction of the computer system of the artificial intelligence of the cyborg or the android. The relativity to time has been defined in the one natural language. Associative collecting pursues goals that the associative object is completed in the one natural language, that it is defined relative to a time, and that it is uniquely stored for the long term, as well as that it can be found over and over again. A further combination of the received signal-reaction with this phrase builds an associative object of the computer system. With the associative object, an association of the computer system of the artificial intelligence of the cyborg or the android is physically substantiated in the computer system, in the sense of building a substance of the association.

More precisely, this means that an associative object is physically built, wherein the associative object contains the further combination of the received signal-reaction with this phrase.

The phrase which contains the associative object is analytically and abstractly analyzed by the cyborg-interpreter during processing. This phrase is parsed on the single words with the analytical and abstract analyzing. Each parsed word is defined as a part of speech and/or as a part of a sentence. Then, each word of the phrase will be analyzed analytically and abstractly, with regard to the class classification, the polymorphism, the units of measurement, and the intonation. Then, each word of the phrase will be uniquely stored for the long term, classified according to an action in the one natural language, with an analytic entity, with having consideration for the word order of the phrase, relative to the time that has been determined from the sensor reactions to the particular signals of the combination that has been contained in the subjective object, or rather from the reactions of the sensors of at least one sensor group to the particular incoming signals. This means that the time has been obtained from the received signal-reaction of the computer system of the artificial intelligence of the cyborg or the android. The relativity to time has been defined in the one natural language. Such a phrase stored word by word represents an abstract object of the computer system. With the abstract object, a thought of the computer system of the artificial intelligence of the cyborg or the android is physically substantiated in the computer system, in the sense of building a substance of the thought.

More precisely, this means that an abstract object is physically built, wherein the abstract object contains the phrase stored word by word, wherein the abstract object is provided with at least one analytic entity, and wherein the word order of the phrase and the relativity to the time are taken into consideration in the abstract object.

The computer system operates with this abstract object during processing in a working method.

The working method is based on one natural language. In this working method, the internal directives of an abstract subjectivity of the computer system are used. The working method is impelled by the computer system of the artificial intelligence of the cyborg or the android by itself. In the working method, the abstract objects and/or the classes of the abstract objects are processed by the computer system of the artificial intelligence of the cyborg or the android in a nonpermanent, in the sense of a noncontinuous treatment mode, that means discretely, for each abstract object or rather the class of the abstract object. The decision, whether an abstract object is to be handled and how the abstract object is to be handled within the bounds of the determined treatment mode, is determined with the classification tree of the computer system of the artificial intelligence of the cyborg or the android. The treatment mode is determined with a function polymorphism of the computer system of the artificial intelligence of the cyborg or the android or rather the treatment mode can directly be designated. The abstract objects and the classes of the abstract objects are classified by the of the computer system of the artificial intelligence of the cyborg or the android by itself, subjectively, and in the one natural language. With the working method more than ten internal directives of the abstract subjectivity of the computer system can be used.

The abstract object can be found by the computer system over and over again. The associative object will be found corresponding to the abstract object. The subjective object will be found corresponding to the associative object.

The subjective object can be returned.

The subjective object will be split according to all sensor groups of one sense into the sensor reactions to the particular signals for all sensor groups of one sense. Then on its return, the sensor reactions will be disassembled into the reactions of the sensors of the sensor group to the particular outcoming signal for output. The output mode, output value, and output unit of measurement will be defined for each output interface of the sensor groups.

The computer system uses one natural language for the working method. For the working method in the first, original, natural language, the computer system can use references in another natural language to words in the first, original, natural language. But the references, i.e. the abstract objects in another natural language, in another natural language to the abstract objects in the first, original, natural language, are used by the computer system during the working method in the other natural language. The same logic will be used for several natural languages.

The subjective object (the received signal-reaction), the associative object (the corresponding association), the abstract object (the corresponding thought) are physically substantiated as the appropriate pointers.

In general, a pointer is about a physical particular area of a computer memory, both the physical particular area of the computer memory where some data is allocated and the other physical particular area of the computer memory which points to the first one (the pointer in which the given back addresses of the computer memory are stored).

(I ask to be excused for the following such a primitive example.)

In the simplest case, this patent application is about a computer system and a working method of the computer system, wherein the computer system comprises, for example, total primitively, a computer memory module (a Random Access Memory (RAM) module), for example, a Kingston computer memory module KVR667D2N5/1G.

The subjective object (a substance of a combination of the sensor reactions to the particular signals) of the computer system of the artificial intelligence of a cyborg or an android is not the input of one sensor reaction to the particular signals or n sensor reactions to the particular signals from n sensor groups. The subjective object (the substance of the combination of the sensor reactions to the particular signals) of the computer system of the artificial intelligence of the cyborg or the android is a first pointer in which the given back RAM (Random Access Memory) addresses of the inputs of all sensor reactions to the particular signals from all sensor groups of at least five senses equipped with sense organs (or rather from all sensor groups of the sense of sight, all sensor groups of the sense of hearing, all sensor groups of the sense of smell, all sensor groups of the sense of taste, all sensor groups of the sense of touch, and thereto all sensor groups of all other senses that are equipped with sense organs) are stored. The first pointer is identified as a received signal-reaction of the computer system of the artificial intelligence of the cyborg or the android.

In other words, the first pointer stores at least five RAM addresses, or rather the first pointer points to at least five RAM addresses.

The computer system of the artificial intelligence does not know sensors or inputs of the sensors. The computer system of the artificial intelligence only knows the Random Access Memory (RAM) addresses of the inputs.

The associative object (a substance of the further combination of the received signal-reaction with a phrase) of the computer system of the artificial intelligence of the cyborg or the android is also a pointer in which the given back RAM (Random Access Memory) addresses are stored. That is that the subjective object, or rather the first pointer that is identified as the subjective object, after it has been completed associatively and relative to the time, will be stored in the Random Access Memory (RAM) of the computer system of the artificial intelligence of the cyborg or the android at run-time as a second pointer. With the second pointer the associative object (the substance of the further combination of the received signal-reaction with the phrase) will be built. The second pointer is identified as the corresponding association of the computer system of the artificial intelligence of the cyborg or the android.

In other words, the computer system of the artificial intelligence knows the at least five Random Access Memory (RAM) addresses of the subjective object only as one corresponding association.

The abstract object (a substance of a phrase stored word by word, wherein the abstract object is provided with at least one analytic entity, and wherein the word order of the phrase and the relativity to the time are taken into consideration in the abstract object) of the computer system of the artificial intelligence of the cyborg or the android is not a word or a semantic utterance or a sentence. The abstract object (the substance of the phrase stored word by word) of the computer system of the artificial intelligence of the cyborg or the android is a third pointer on the vocabulary of the computer system. The given back Random Access Memory (RAM) addresses of the computer memory area in which each word of the vocabulary of the computer system of the artificial intelligence of the cyborg or the android is mapped are stored in this third pointer. The third pointer is identified as the corresponding thought of the computer system of the artificial intelligence of the cyborg or the android.

In other words, the computer system of the artificial intelligence processes the at least five Random Access Memory (RAM) addresses of the subjective object only as the one corresponding association, wherein processing the one corresponding association takes place only in the one natural language by means of the corresponding thought.

The screw anchor is known from the British Patent (GB 22680/11). The wall plug was invented by John Joseph Rawlings in 1911, and marketed under the name Rawlplug. This patent is about the particular physical area of a wall. The instant patent application is about the particular physical area of a hardware device, total primitively, of a computer memory module, of a Random Access Memory (RAM) module. In addition, the particular physical areas of Random Access Memory (RAM) of the instant patent application are accessed, classified, and connected together only by one natural language.

The computer system of the artificial intelligence of the cyborg or the android transforms some particular artifacts (the reactions of the sensors of all sensor groups to the particular incoming signals) into some different things. The computer system of the artificial intelligence of the cyborg or the android transforms all reactions of all sensors of all sensor groups of at least five senses equipped with sense organs to the particular incoming signals, wherein the senses are a sense of sight, a sense of hearing, a sense of smell, a sense of taste, and a sense of touch, wherein the senses are built-in parts of the artificial intelligence of the cyborg or the android, and wherein each sense organ is equipped with at least one sensor group, into the subjective object of the computer system of the artificial intelligence of the cyborg or the android, then the computer system of the artificial intelligence of the cyborg or the android transforms the subjective object into the associative object of the computer system of the artificial intelligence of the cyborg or the android, and then the computer system of the artificial intelligence of the cyborg or the android transforms the associative object into the abstract object of the computer system of the artificial intelligence of the cyborg or the android. The final results, the pointers, are useful, concrete, and tangible. The subjective object (the received signal-reaction), the associative object (the corresponding association), the abstract object (the corresponding thought) are physically substantiated as the corresponding pointers. Furthermore, the corresponding pointers are accessed, classified, and connected together only by the one natural language.

FIG. 1B shows a detailed drawing of the hardware devices node of the sensor groups of the sense of sight and, for example, a detailed drawing of the hardware devices node of the sensor groups of the n-sense. The detailed drawings show the sensor reaction to the see signals from the sensor groups of the sense of sight and, for example, the sensor reaction to the signals of the n-sense from the sensor groups of the n-sense.

The instant invention recites three elements of the invention in relation to the received signal-reaction, to the subjective object.

1. First, this is the reaction of one sensor.

The reaction component of one sensor of the sense of sight 38 is the reaction of one sensor of the sense of sight; the reaction component of one sensor of the n-sense 39 is the reaction of one sensor of the n-sense.

2. Second, this is the sensor reaction of one sense; the sensor reaction summarized all reactions of all sensors of one sense.

The sensor reaction component of the sense of sight 40 is the sensor reaction of the sense of sight; the sensor reaction component of the n-sense 41 is the sensor reaction of the n-sense.

3. Third, this is the received signal reaction that summarized all sensor reactions.

At least five sensor groups of the sensor network of the computer system of the artificial intelligence of the cyborg or the android, the sensor group of the sense of sight, the sensor group of the sense of hearing, the sensor group of the sense of smell, the sensor group of the sense of taste, and the sensor group of the sense of touch, receive the incoming signals, summarize the reactions of the sensors of each sensor group into sensor reactions, one sensor reaction to the particular signals from all sensor groups of one sense, and forward the sensor reactions to the particular signals at the same time. With the appropriate input interfaces, the seeing input interface, the hearing input interface, the smelling input interface, the degusting input interface, and the touching input interface, the five sensor reactions to the particular signals come at the same time to the senses input receiver. The senses input receiver builds a subjective object that contains a combination of all sensor reactions to the particular signals from all sensor groups of all senses. The subjective object is the received signal-reaction of the computer system of the artificial intelligence of the cyborg or the android. The received signal-reaction of the computer system of the artificial intelligence of the cyborg or the android contains then the combination of all sensor reactions to the particular signals.

In another implementation, first, the sensor network of the computer system of the artificial intelligence of the cyborg or the android forwards all reactions of all sensors of all sensor groups of at least five senses equipped with sense organs to the senses input receiver. Second, the senses input receiver summarizes the reactions of the sensors of the sensor groups into the sensor reactions to the particular signals, wherein one sensor reaction to the particular signals summarizes all reactions of all sensors of all sensor groups of one sense which the particular signals belong to. More precisely, this means that one sensor reaction to the particular signals summarizes all reactions of all sensors of all sensor groups of one sense to the particular signals, wherein the particular signals belong to the one sense. Third, the senses input receiver builds a subjective object that contains a combination of all sensor reactions to the particular signals. The subjective object is the received signal-reaction of the computer system of the artificial intelligence of the cyborg or the android. The received signal-reaction of the computer system of the artificial intelligence of the cyborg or the android contains then the combination of all sensor reactions to the particular signals from all sensor groups of at least five senses equipped with sense organs, wherein the senses are a sense of sight, a sense of hearing, a sense of smell, a sense of taste, and a sense of touch.

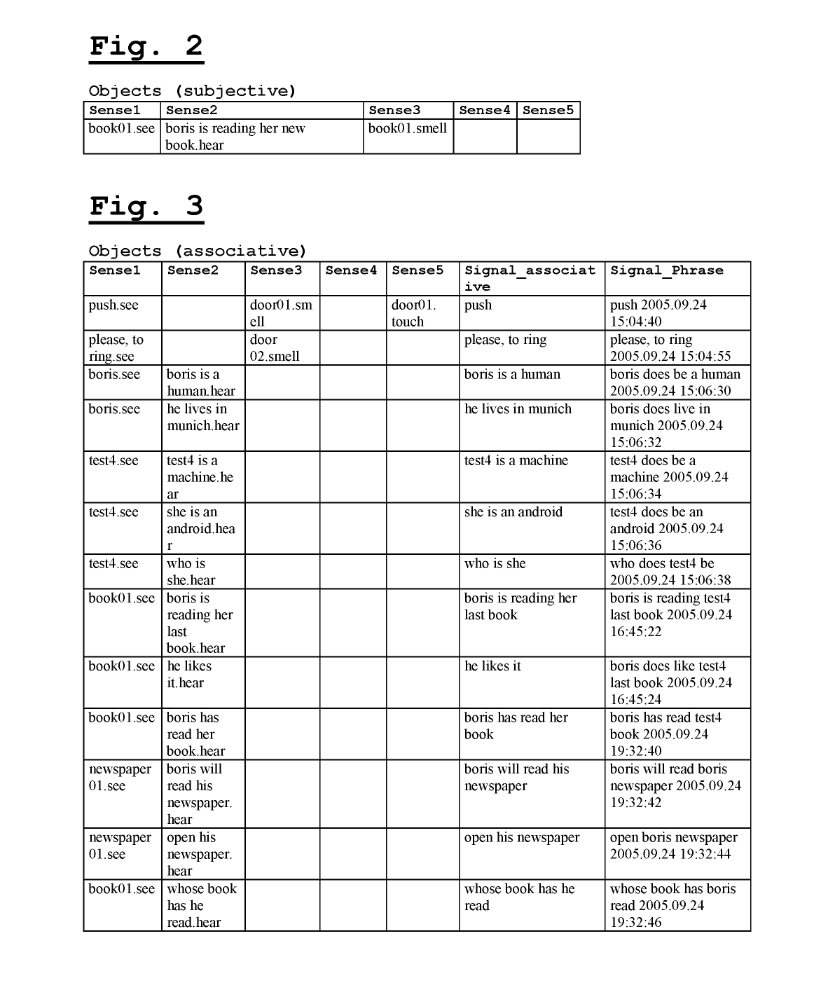

FIG. 2 illustrates the received signal-reaction of the computer system of the artificial intelligence of the cyborg or the android (the subjective object) and the working method for building the combination of the sensor reactions to the particular signals. The subjective object contains a combination of all sensor reactions to the particular signals (i.e. a combination of at least five subjective sensor reactions to the particular signals) from all sensor groups of at least five senses equipped with sense organs, wherein the senses are a sense of sight, a sense of hearing, a sense of smell, a sense of taste, and a sense of touch. This means that the subjective object contains a combination of one sensor reaction to the see signals from the sensor groups of the sense of sight, one sensor reaction to the hear signals from the sensor groups of the sense of hearing, one sensor reaction to the smell signals from the sensor groups of the sense of smell, one sensor reaction to the taste signals from the sensor groups of the sense of taste, one sensor reaction to the touch signals from the sensor groups of the sense of touch, and thereto all sensor reactions to the particular signals from all sensor groups of all other senses that are equipped with sense organs, wherein each sense organ is equipped with at least one sensor group.

The Sense1 stands for the sensor reaction to the see signals from the sensor groups of the sense of sight, the Sense2 stands for the sensor reaction to the hear signals from the sensor groups of the sense of hearing, the Sense3 stands for the sensor reaction to the smell signals from the sensor groups of the sense of smell, the Sense4 stands for the sensor reaction to the taste signals from the sensor groups of the sense of taste, and the Sense5 stands for the sensor reaction to the touch signals from the sensor groups of the sense of touch. The Sense6 can be used and can stand for the sensor reaction to the n-sense signals from the sensor groups of the n-sense.

Each subjective object is unique relative to the Sense1 (the sensor reaction to the see signals from the sensor groups of the sense of sight), the Sense2 (the sensor reaction to the hear signals from the sensor groups of the sense of hearing), the Sense3 (the sensor reaction to the smell signals from the sensor groups of the sense of smell), the Sense4 (the sensor reaction to the taste signals from the sensor groups of the sense of taste), and the Sense5 (the sensor reaction to the touch signals from the sensor groups of the sense of touch). If the Sense6 is used, each subjective object is unique relative to the Sense1, the Sense2, the Sense3, the Sense4, the Sense5, and the Sense6.

The received signal-reaction of the computer system of the artificial intelligence of the cyborg or the android (the subjective object of the computer system of the artificial intelligence of the cyborg or the android) will be deleted from the system after the data processing. Conversely, this means that the received signal-reaction of the computer system of the artificial intelligence of the cyborg or the android (the subjective object) is not stored in the computer system for the long term.

In an implementation with a database, the columns definition of the database gives the possibility to store an appropriate sensor reaction to the particular signals in each column, wherein one sensor reaction to the particular signals summarizes all reactions of all sensors of all sensor groups of one sense which the particular signals belong to. In another implementation with a database, only the names of files are stored in the database.

In the implementation with the database, the received signal-reaction of the computer system of the artificial intelligence of the cyborg or the android (the subjective object of the computer system of the artificial intelligence of the cyborg or the android) will be deleted from the database after the data processing.

The received signal-reaction of the computer system of the artificial intelligence of the cyborg or the android (the subjective object) is not handled relative to a time.

With the subjective object, that contains the combination of the sensor reactions to the particular signals, the received signal-reaction of the computer system of the artificial intelligence of the cyborg or the android is physically substantiated in the computer system of the artificial intelligence of the cyborg or the android, in the sense of building a substance of the signal-reaction of the computer system of the artificial intelligence of the cyborg or the android.

More precisely, this means that a subjective object is physically built, wherein the subjective object contains the combination of the sensor reactions to the particular signals.

(The table Objects (subjective) is implemented with the generic primary key relative to all database columns Sense1, Sense2, Sense3, Sense4, and Sense5. The primary key of the table Objects (subjective) is created without the specific computer language database column types for the primary key, for example, Integer, Number, Universal Unique Identifier, Global Unique Identifier, etc. but with the database column combination from this table. The other database tables are created in the same way. This means that all database tables are created without the specific computer language database column types for the primary keys.)

FIG. 3 illustrates the corresponding association of the computer system of the artificial intelligence of the cyborg or the android (the associative object) and the working methods for an associative recognition by the computer system of the artificial intelligence of the cyborg or the android and a cleanup of the corresponding associations of the computer system of the artificial intelligence of the cyborg or the android.

With the associative recognition, the computer system of the artificial intelligence of the cyborg or the android transforms the received signal-reaction of the computer system of the artificial intelligence of the cyborg or the android to a phrase of one natural language. The computer system of the artificial intelligence of the cyborg or the android analyzes the received signal-reaction in the one natural language with respect to other associations of the computer system of the artificial intelligence of the cyborg or the android. After processing by the cyborg-interpreter, this phrase is completed and it is provided with a time, wherein the computer system completes the received signal-reaction in the one natural language relative to the time, wherein the computer system works in the one natural language, and the computer system completes the received signal-reaction in the one natural language associatively to the computer system of the artificial intelligence of the cyborg or the android, wherein the computer system works in the one natural language, wherein at least one corresponding association corresponds with at least one received signal-reaction, wherein the corresponding association corresponds with the received signal-reaction in the one natural language. A further combination of the received signal-reaction with the phrase builds an associative object of the computer system of the artificial intelligence of the cyborg or the android. The associative object of the computer system of the artificial intelligence of the cyborg or the android is handled relative to a time. The time has been determined from the sensor reactions to the particular signals of the combination that has been contained in the subjective object, or rather from the reactions of the sensors of at least one sensor group to the particular incoming signals. This means that the time has been obtained from the received signal-reaction of the computer system of the artificial intelligence of the cyborg or the android. The associative object of the computer system of the artificial intelligence of the cyborg or the android is not uniquely handled relative to time. The relativity to time has been defined in the one natural language. Associative collecting pursues goals that the associative object is completed in the one natural language, that it is defined relative to a time, and that it is uniquely stored for the long term, as well as that it can be found over and over again.

The associative object contains the further combination of all sensor reactions to the particular signals (i.e. a combination of at least five subjective sensor reactions to the particular signals) from all sensor groups of at least five senses equipped with sense organs, wherein the senses are a sense of sight, a sense of hearing, a sense of smell, a sense of taste, and a sense of touch, and the phrase. This means that the subjective object contains a combination of one sensor reaction to the see signals from the sensor groups of the sense of sight, one sensor reaction to the hear signals from the sensor groups of the sense of hearing, one sensor reaction to the smell signals from the sensor groups of the sense of smell, one sensor reaction to the taste signals from the sensor groups of the sense of taste, one sensor reaction to the touch signals from the sensor groups of the sense of touch, and thereto all sensor reactions to the particular signals from all sensor groups of all other senses that are equipped with sense organs, wherein each sense organ is equipped with at least one sensor group, and the phrase. The Sense1 stands for the sensor reaction to the see signals from the sensor groups of the sense of sight, the Sense2 stands for the sensor reaction to the hear signals from the sensor groups of the sense of hearing, the Sense3 stands for the sensor reaction to the smell signals from the sensor groups of the sense of smell, the Sense4 stands for the sensor reaction to the taste signals from the sensor groups of the sense of taste, the Sense5 stands for the sensor reaction to the touch signals from the sensor groups of the sense of touch, and the Signal Phrase stands for the phrase. The Sense6 can be used and can stand for the sensor reaction to the n-sense signals from the sensor groups of the n-sense.

With the associative object, that contains the further combination of all sensor reactions to the particular signals from all sensor groups of at least five senses equipped with sense organs, wherein the senses are a sense of sight, a sense of hearing, a sense of smell, a sense of taste, and a sense of touch, and wherein each sense organ is equipped with at least one sensor group, one sensor reaction to the see signals from all sensor groups of the sense of sight, one sensor reaction to the hear signals from all sensor groups of the sense of hearing, one sensor reaction to the smell signals from all sensor groups of the sense of smell, one sensor reaction to the taste signals from all sensor groups of the sense of taste, one sensor reaction to the touch signals from all sensor groups of the sense of touch, and the phrase, an association of the computer system of the artificial intelligence of the cyborg or the android is physically substantiated in the computer system, in the sense of building a substance of the association.

More precisely, this means that an associative object is physically built, wherein the associative object contains the further combination of the received signal-reaction with the phrase.

The corresponding association of the computer system of the artificial intelligence of the cyborg or the android (the associative object) is uniquely stored for the long term.

The corresponding association of the computer system of the artificial intelligence of the cyborg or the android (the associative object) is unique with respect to the phrase of the associative object of the computer system of the artificial intelligence of the cyborg or the android, wherein the phrase is related to the sense of the phrase (under the sense of the phrase, this means, the sense from which the phrase is determined, i.e. Sense1, Sense2, Sense3, Sense4, Sense5, and Sense6). The phrase of the associative object can also be determined from two or more senses. In this case, the phrase with respect to which the corresponding association is unique is related to the two or more senses. This means that the associative object of the computer system of the artificial intelligence of the cyborg or the android is unique with respect to the association.

(The primary key of the table Objects (associative) is created without the specific computer language database column types for the primary key, for example, Integer, Number, Universal Unique Identifier, Global Unique Identifier, etc. but with the database column combination from this table. The other database tables are created in the same way. This means that all database tables are created without the specific computer language database column types for the primary keys.)

FIG. 3 also is an illustration of the working method for the cleanup of the corresponding associations of the computer system of the artificial intelligence of the cyborg or the android. Because the associative object is unique relative to the phrase, wherein the phrase is related to the sense of the phrase (under the sense of the phrase, this means, the sense from which the phrase is determined, i.e. Sense1, Sense2, Sense3, Sense4, Sense5, and Sense6), an already existing old associative object will automatically be deleted with a new associative object that contains the same phrase, wherein the phrase is related to the same sense of the phrase as the phrase of the already existing old associative object, or rather the already existing old associative object will be forgotten, if the computer system of the artificial intelligence of the cyborg or the android obtains the new associative object with the same phrase. More precisely, this means that the already existing old associative object is replaced or rather is overwritten with the new associative object that contains the same phrase which is determined from the same sense from which the phrase of the already existing old associative object is determined. If the phrase of the already existing old associative object is determined from two or more senses, the already existing old associative object is overwritten with the new associative object that contains the same phrase which is determined from the same two or more senses from which the phrase of the already existing old associative object is determined.

If the computer system of the artificial intelligence of the cyborg or the android does not obtain any new associative objects, the cleanup will occur in a sleeping scenario in a dreaming mode.

In the sleeping scenario in the dreaming mode, a corresponding abstract object is built that is corresponded to an artificial fictitious associative object.
1. The corresponding abstract object, which is corresponded to the artificial fictitious associative object, belongs to the same class to which one of the last associative objects belongs. This means that the corresponding abstract object, which is corresponded to the artificial fictitious associative object, belongs to the same class to with the corresponding abstract object, which is corresponded to this one of the last associative objects, belongs. As a result, the artificial fictitious associative object belongs to the same class to which one of the last associative objects belongs.
2. The corresponding abstract object, which is corresponded to the artificial fictitious associative object, has at least one equal attribute in common with the corresponding abstract object, which is corresponded to this one of the last associative objects.

More precisely, a plurality of such corresponding abstract objects which are corresponded to the artificial fictitious associative objects will be built during the sleeping scenario in the dreaming mode. Each artificial fictitious associative object contains an artificial fictitious phrase that is supplied with the words of the phrases of the last associative objects, wherein the words of the phrases of the last associative objects have been selected at random. More precisely, the words of the artificial fictitious phrase of each artificial fictitious associative object will be supplied with diverse attribute values of the corresponding abstract objects that are corresponded to diverse already existing old or rather the last real associative objects (this means, the diverse already existing old or rather the last real associations), wherein the diverse already existing old or rather the last real associative objects are selected at random.

In a sleeping scenario in a dreaming mode, one is operating with the corresponding abstract objects, the majority of which are corresponded to the artificial fictitious associative objects.

During the dreaming mode, the artificial fictitious associative objects, to which the corresponding abstract objects in the dreaming mode are corresponded, are stored in the computer system of the artificial intelligence as well.

The artificial fictitious associative object contains a subjective object with the combination of all sensor reactions to the particular signals from all sensor groups of at least five senses equipped with sense organs, the Sense1 (the sensor reaction to the see signals from the sensor groups of the sense of sight), the Sense2 (the sensor reaction to the hear signals from the sensor groups of the sense of hearing), the Sense3 (the sensor reaction to the smell signals from the sensor groups of the sense of smell), the Sense4 (the sensor reaction to the taste signals from the sensor groups of the sense of taste), the Sense5 (the sensor reaction to the touch signals from the sensor groups of the sense of touch), and also for example the Sense6 (the sensor reaction to the n-sense signals from the sensor groups of the n-sense). All sensor reactions to the particular signals of the subjective object that is contained in the majority of the artificial fictitious associative objects are initialized with NULL.

The associative object is unique relative to the phrase, wherein the phrase is related to the sense of the phrase. Because in the artificial fictitious associative object all sensor reactions to the particular signals of the subjective object that is contained in the artificial fictitious associative object are initialized with NULL, i.e. all senses to which the Phrase may be related are initialized with NULL, the Phrase cannot be determined from at least one sense. However, this would have meant that the Phrase could be determined from each sense. In the sleeping scenario in the dreaming mode, by executing, the artificial fictitious associative objects are mixed at random with the diverse already existing old real associative objects. After obtaining of one artificial fictitious associative object, in which all sensor reactions to the particular signals of the subjective object that is contained in the artificial fictitious associative object are initialized with NULL, or rather in which the Phrase cannot be determined from at least one sense, the already existing old associative object that contains the same phrase as the phrase of the artificial fictitious associative object will be deleted.

However, there are some artificial fictitious associative objects that contain a subjective object that is built with a couple of sensor reactions to the particular signals that are initialed with some values. In the sleeping scenario in the dreaming mode, by executing, the artificial fictitious associative objects are mixed at random with the diverse already existing old real associative objects. After obtaining of one artificial fictitious associative object, the already existing old associative object that contains the same phrase as the phrase of the artificial fictitious associative object, wherein the phrase is related to the same sense of the phrase as the phrase of the artificial fictitious associative object, will be deleted, because the associative object is unique relative to the phrase, wherein the phrase is related to the sense of the phrase (under the sense of the phrase, this means, the sense from which the phrase is determined, i.e. Sense1, Sense2, Sense3, Sense4, Sense5, and Sense6).

This means that the already existing old associative object is replaced or rather is overwritten with the artificial fictitious associative object.

After finishing of the sleeping scenario and after a short time period for further executing, each associative object that contains the subjective object with all sensor reactions to the particular signals which are initialized with NULL will be deleted. After that, the remaining artificial fictitious associative objects that contain the subjective objects that were built with a couple of sensor reactions to the particular signals that were initialed with some values will be deleted. This means that after the short time period for further executing the artificial fictitious associative objects that were temporary built will have been deleted.

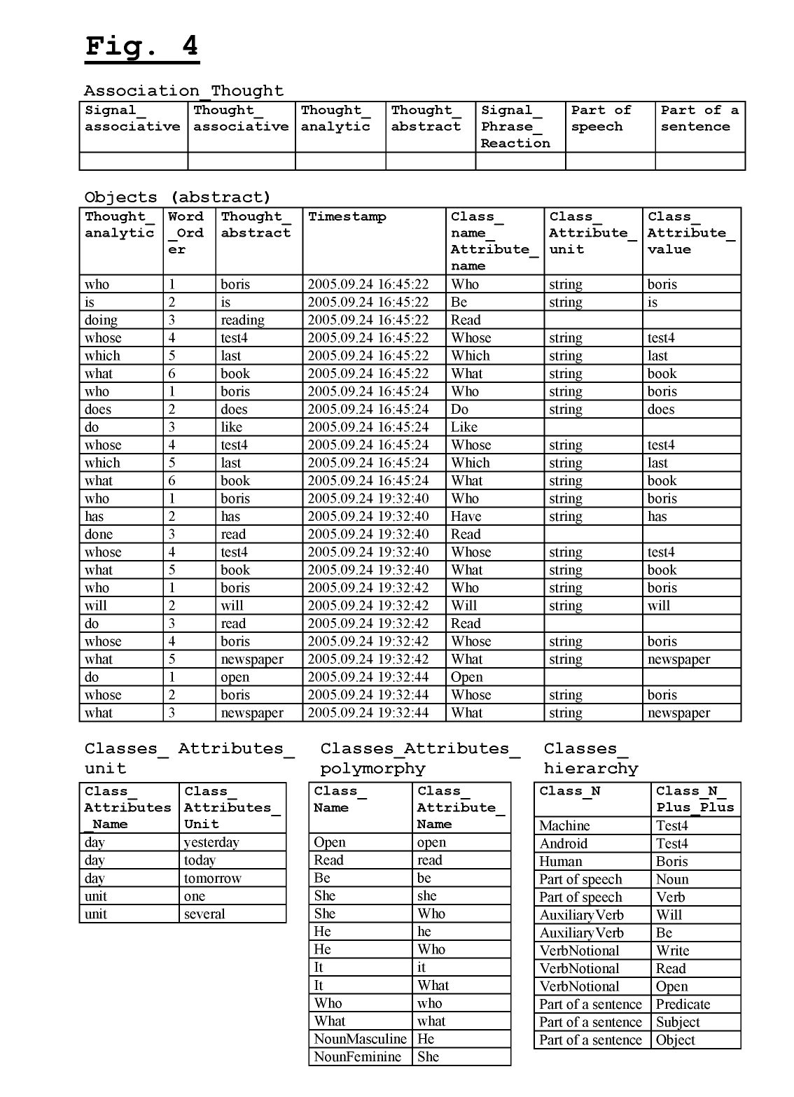

FIG. 4 illustrates the corresponding thought of the computer system of the artificial intelligence of the cyborg or the android (the abstract object) and the working methods for abstract analyzing of the corresponding association in one natural language, for transforming the corresponding association into a corresponding thought (the abstract object) of the computer system of the artificial intelligence of the cyborg or the android in the one natural language, for operating the corresponding thought, for storing the corresponding thought, and for finding the corresponding association again.

The computer system stores the phrase of the associative object just as many times as many words are included in the phrase of the associative object. This means that each storing relates to one word of the phrase of the associative object. All the stored entries are processed. The phrase of the associative object is parsed on the single words with the analytical and abstract analyzing in one natural language. Each parsed word of the phrase of the associative object is parsed, analyzed, processed, completed etc. in the one natural language by the computer system of the artificial intelligence of the cyborg or the android. Each parsed word of the phrase of the associative object is defined as a part of speech and/or as a part of a sentence. Then, each word of the phrase will be analyzed analytically and abstractly, with regard to the class classification, the polymorphism, the units of measurement, and the intonation. All the stored entries are transformed into one corresponding thought of the computer system of the artificial intelligence of the cyborg or the android (one abstract object).

Each storing is provided with an analytic entity. The stored entries with the analytic entities are completed to a summarized phrase stored word by word. Each word of the summarized phrase will be uniquely stored within the time frame for thinking, classified according to an action in the one natural language, with an analytic entity, with having consideration for the word order of the phrase. Such a summarized phrase stored word by word builds an abstract object of the computer system of the artificial intelligence of the cyborg or the android. The abstract object of the computer system of the artificial intelligence of the cyborg or the android is handled relative to a time. The time has been determined from the sensor reactions to the particular signals of the combination that has been contained in the subjective object, or rather from the reactions of the sensors of at least one sensor group to the particular incoming signals. This means that the time has been obtained from the received signal-reaction of the computer system of the artificial intelligence of the cyborg or the android. The abstract object is not uniquely handled relative to time. The relativity to time has been defined in the one natural language. With the abstract object, a thought of the computer system of the artificial intelligence of the cyborg or the android is physically substantiated in the computer system, in the sense of building a substance of the thought.

The abstract object is unique with respect to a complete combination of words of a vocabulary, wherein the complete combination includes both analytic words and abstract words which are words of a phrase of the association. The abstract object can be unique with respect to the complete combination of the words of the vocabulary, wherein the complete combination includes only the abstract words which are the words of the phrase of the association.

The abstract object of the computer system of the artificial intelligence of the cyborg or the android (the corresponding thought of the computer system of the artificial intelligence of the cyborg or the android) will be deleted from the computer system after the time frame for thinking.

In another implementation with a database, the computer system writes the associative object into the table Association Thought. The table is a dynamic table. By a dynamic table, at least one process writes data into the dynamic table, at least one process updates data in the dynamic table, at least one process deletes data from the dynamic table, at least one process reads data from the dynamic table etc. A dynamic table is the state of the art (prior art) and the functionality of a dynamic table is known each person skilled in the art.

Thus, the computer system of the artificial intelligence of the cyborg or the android writes the phrase of the associative object into the dynamic table Association Thought with just as many rows as many words are included in the phrase of the associative object. (The row count of the dynamic table equals the word count of the phrase that the associative object contains.) This means that one row corresponds to one word of the phrase of the associative object.

All the table rows are processed. The phrase of the associative object is parsed on the single words with the analytical and abstract analyzing in one natural language. Each parsed word of the phrase of the associative object is parsed, analyzed, processed, completed etc. in the one natural language by the computer system of the artificial intelligence of the cyborg or the android. Each parsed word of the phrase of the associative object is defined as a part of speech and/or as a part of a sentence. Then, each word of the phrase will be analyzed analytically and abstractly, with regard to the class classification, the polymorphism, the units of measurement, and the intonation. All the table rows are transformed into one corresponding thought of the computer system of the artificial intelligence of the cyborg or the android (one abstract object).

Each table row is provided with an analytic entity. The table rows with the analytic entities are completed to a summarized phrase stored word by word. Each word of the summarized phrase will be uniquely stored within the time frame for thinking, classified according to an action in the one natural language, with an analytic entity, with having consideration for the word order of the phrase. Such a summarized phrase stored word by word builds an abstract object of the computer system of the artificial intelligence of the cyborg or the android. The abstract object of the computer system of the artificial intelligence of the cyborg or the android is handled relative to a time. The time has been determined from the sensor reactions to the particular signals of the combination that has been contained in the subjective object, or rather from the reactions of the sensors of at least one sensor group to the particular incoming signals. This means that the time has been obtained from the received signal-reaction of the computer system of the artificial intelligence of the cyborg or the android. The abstract object is not uniquely handled relative to time. The relativity to time has been defined in the one natural language. The abstract object, or rather the summarized phrase stored word by word, is implemented in the table Objects (abstract) in the columns Thought_analytic and Thought_abstract. The abstract object is unique with respect to a complete combination of words of a vocabulary, wherein the complete combination includes both analytic words and abstract words which are words of a phrase of the association. The abstract object can be unique with respect to the complete combination of the words of the vocabulary, wherein the complete combination includes only the abstract words which are the words of the phrase of the association. With the abstract object, a thought of the computer system of the artificial intelligence of the cyborg or the android is physically substantiated in the computer system, in the sense of building a substance of the thought.

More precisely, this means that an abstract object is physically built, wherein the abstract object contains the summarized phrase stored word by word, wherein the abstract object is provided with at least one analytic entity, and wherein the word order of the phrase and the relativity to the time are taken into consideration in the abstract object.

The computer system of the artificial intelligence of the cyborg or the android operates with this abstract object during processing.

The abstract objects and/or the classes of the abstract objects are processed by the computer system of the artificial intelligence of the cyborg or the android in a nonpermanent, in the sense of a noncontinuous treatment mode, that means discretely, for each abstract object or rather the class of the abstract object. The decision, whether an abstract object is to be handled and how the abstract object is to be handled within the bounds of the determined treatment mode, is determined with the classification tree of the computer system of the artificial intelligence of the cyborg or the android. The treatment mode is determined with a function polymorphism of the computer system of the artificial intelligence of the cyborg or the android or rather the treatment mode can directly be designated. The abstract object can be found by the computer system over and over again. The associative object will be found corresponding to the abstract object. The subjective object will be found corresponding to the associative object. The subjective object can be returned.

In the implementation with the database, the abstract object of the computer system of the artificial intelligence of the cyborg or the android (the corresponding thought of the computer system of the artificial intelligence of the cyborg or the android) will be deleted from the database after the time frame for thinking.

FIG. 5 illustrates splitting the subjective object according to all sensor groups of each sense into the sensor reactions and disassembling the sensor reactions into the reactions of the sensors for output, and the working method for returning the subjective object from the computer system.

The instant invention recites three elements of the invention in relation to the received signal-reaction, to the subjective object.

1. First, this is the reaction of one sensor.

2. Second, this is the sensor reaction of one sense; the sensor reaction summarized all reactions of all sensors of one sense.

3. Third, this is the received signal reaction that summarized all sensor reactions.

The senses output transmitter provides for the output the subjective object (the subjective object is the received signal-reaction) split according to all sensor groups of one sense into the sensor reactions to the particular signals for all sensor groups of one sense. This means that the senses output transmitter provides for the output all sensor reactions to the particular signals for all sensor groups of all senses equipped with sense organs, i.e. one sensor reaction to the see signals for all sensor groups of the sense of sight, one sensor reaction to the hear signals for all sensor groups of the sense of hearing, one sensor reaction to the smell signals for all sensor groups of the sense of smell, one sensor reaction to the taste signals for all sensor groups of the sense of taste, and one sensor reaction to the touch signals for all sensor groups of the sense of touch, and transmits the sensor reactions to the particular signals at the same time. In the same way, the senses output transmitter provides for the output the sensor reaction to the n-sense signals for all sensor groups of the n-sense. The output mode, output value, and output unit of measurement will be defined for each output interface of the sensor groups. By means of the five output interfaces: the show output interface, the sound output interface, the scent output interface, the taste output interface, and the touch output interface, the five sensor reactions to the particular signals are disassembled into the reactions of the sensors of each sensor group to the particular outcoming signal for output. The sixth output interface realizes the output interface of the n-sense. The sixth output interface disassembles the sensor reaction of the n-sense into the reactions of the sensors of each sensor group of the n-sense for output.

The subjective object of the computer system of the artificial intelligence of the cyborg or the android will be deleted from the system after the data processing.

In another implementation with a database in the table Reactions, on the return of the subjective object, the subjective object is split according to all sensor groups of one sense into the sensor reactions to the particular signals for all sensor groups of one sense with the output modes: React_Object1, React_Object2, React_Object3, React_Object4, React_Object5, and the corresponding output values: Sense1, Sense2, Sense3, Sense4, and Sense5. For the n-sense, the output mode React_Object6 and the corresponding output value Sense6 can also be set. In addition, the output units of measurement can also be defined. This means that for the output, on the return of the subjective object, for each sensor reaction to the particular signals, i.e. for each output interface, the show output interface, the sound output interface, the scent output interface, the taste output interface, the touch output interface, and the n-sense output interface, the output mode, the output value, and the output unit of measurement will be defined.

The subjective object of the computer system of the artificial intelligence of the cyborg or the android will be deleted from the table Reactions after the data processing.

The table Reactions is shown in FIG. 5.

In another further implementation, first, the senses output transmitter splits for the output the subjective object according to all sensor groups of one sense into the sensor reactions to the particular signals for all sensor groups of one sense, one sensor reaction to the particular signals for all sensor groups of one sense, i.e. one sensor reaction to the see signals for all sensor groups of the sense of sight, one sensor reaction to the hear signals for all sensor groups of the sense of hearing, one sensor reaction to the smell signals for all sensor groups of the sense of smell, one sensor reaction to the taste signals for all sensor groups of the sense of taste, one sensor reaction to the touch signals for all sensor groups of the sense of touch, and one sensor reaction to the signals of the n-sense for all sensor groups of the n-sense. Second, the senses output transmitter disassembles the sensor reactions into the reactions of the sensors of each sensor group to the particular outcoming signal for output. The output mode, output value, and output unit of measurement are defined for each output interface of the sensor groups.

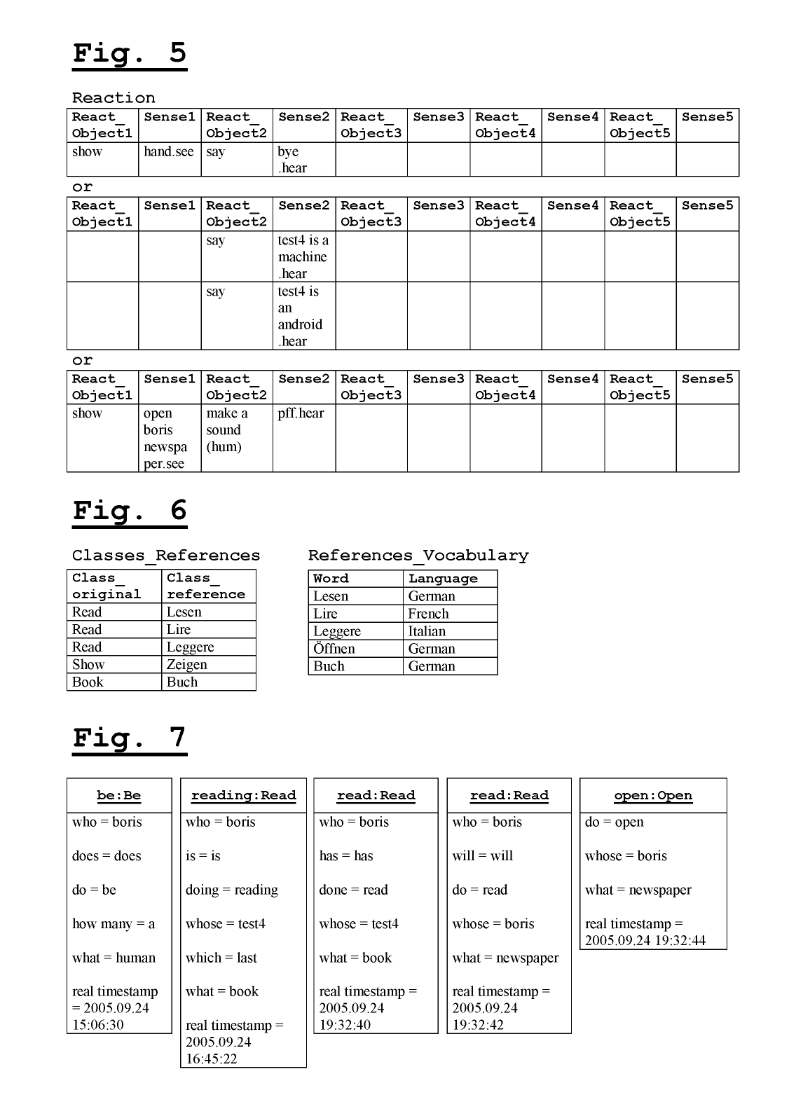

FIG. 6 illustrates the working method of the computer system of the artificial intelligence of the cyborg or the android in another natural language or in several natural languages. The computer system uses one natural language for the working method. For the working method in the first, original, natural language, the computer system uses a word in another natural language as a reference to a word in the first, original, natural language. Thus, it is implemented that the computer system uses only one natural language for its working method.

But for the working method in another natural language, the computer system needs the abstract objects in the other natural language. Therefore, the computer system will use the references (i.e. the abstract objects in another natural language) in another natural language to the abstract objects in the first, original, natural language during the working method in the other natural language.

The same logic will be used for the working methods in several natural languages.

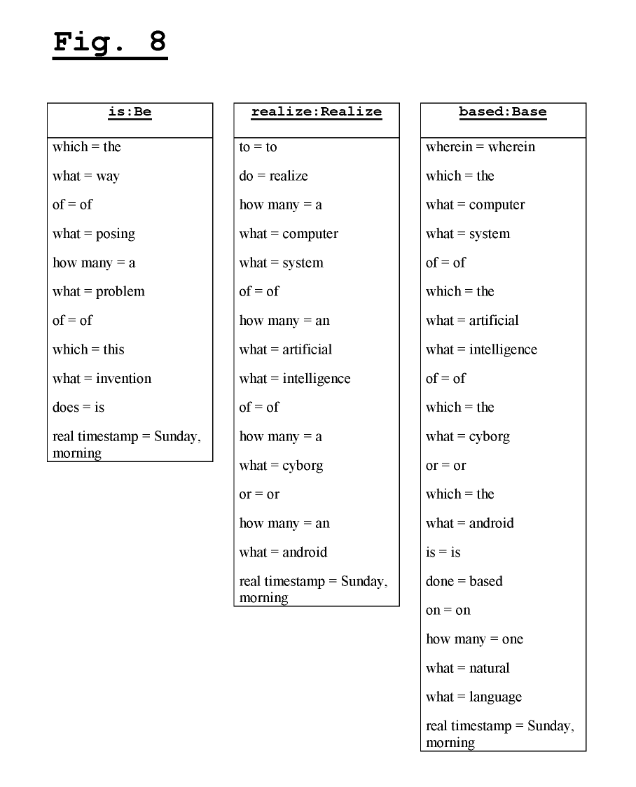

FIG. 7 shows some examples of the abstract objects that are generated in one natural language. First example is one abstract object that is corresponded to the associative object of the table Objects (associative) of FIG. 3 with the phrase “boris does be a human 2005.09.24 15:06:30”. The other examples are the abstract objects of the table Objects (abstract) of FIG. 4 with the summarized phrases: “boris is reading test4 last book 2005.09.24 16:45:22”, “boris has read test4 book 2005.09.24 19:32:40”, “boris will read boris newspaper 2005.09.24 19:32:42”, and “open boris newspaper 2005.09.24 19:32:44”. These abstract objects are also corresponded to the associative objects of the table Objects (associative) of FIG. 3 with the same phrases.

Each abstract object is defined relative to a time (for example is provided with a timestamp). The computer system operates with the abstract objects during its working method. Each abstract object, each associative object, and each subjective object are classified by the computer system as an action in the one natural language and are the corresponding objects of the same class. Each abstract object, each associative object, and each subjective object are connected together only by the one natural language. The classes from the abstract objects, or rather of each abstract object, each associative object, and each subjective object are preprogrammed in no computer language. Each abstract object, each associative object, and each subjective object are also preprogrammed in no computer language.

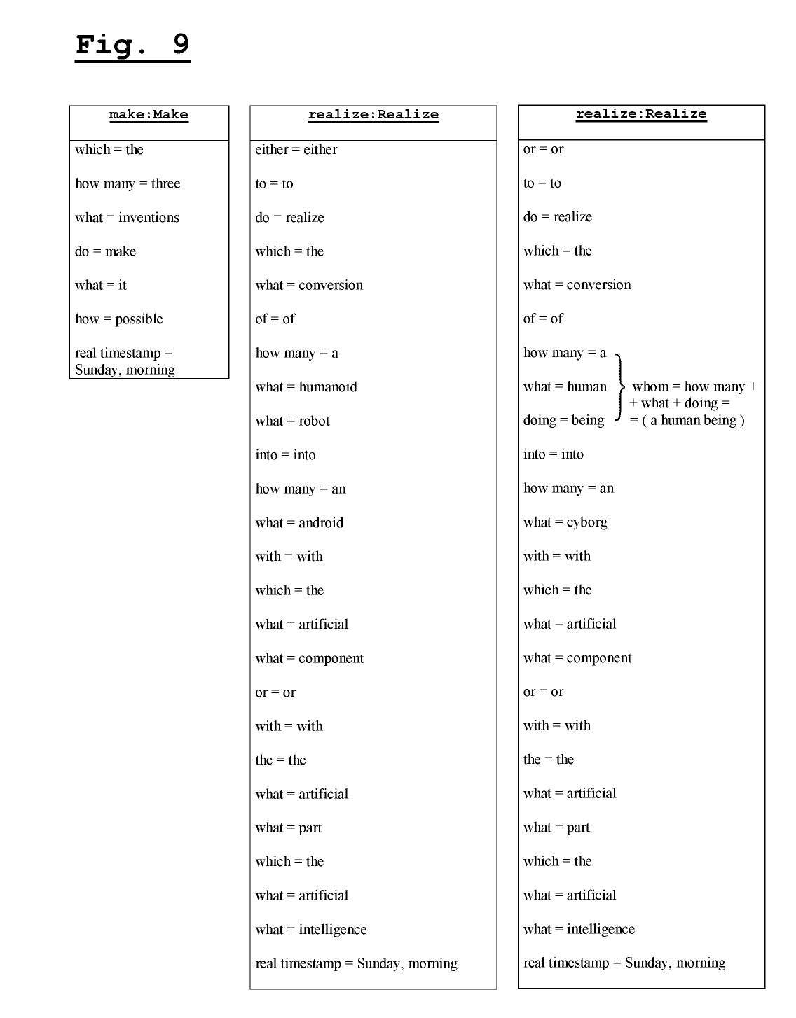

FIG. 8 shows some more examples of the abstract objects that are generated in one natural language. In this patent application, a machine is realized. The machine substantiates the subjective object of the computer system of the artificial intelligence of the cyborg or the android, wherein the subjective object contains a combination of all sensor reactions to the particular signals from all sensor groups of at least five senses equipped with sense organs, the Sense1 (the sensor reaction to one see signal from the sensor groups of the sense of sight), the Sense2 (the sensor reaction to one hear signal from the sensor groups of the sense of hearing), the Sense3 (the sensor reaction to one smell signal from the sensor groups of the sense of smell), the Sense4 (the sensor reaction to one taste signal from the sensor groups of the sense of taste), and the Sense5 (the sensor reaction to one touch signal from the sensor groups of the sense of touch), or rather creates a substance of the received signal-reaction, wherein one sensor reaction to the particular signals summarizes all reactions of all sensors of all sensor groups of one sense which the particular signals belong to.

Further, the machine substantiates the associative object of the computer system of the artificial intelligence of the cyborg or the android from the substance of the received signal-reaction, or rather creates a substance of the corresponding association. Furthermore, the machine substantiates the abstract object of the computer system of the artificial intelligence of the cyborg or the android from the substance of the corresponding association, or rather creates a substance of the corresponding thought. The machine is able to think in the human way or rather to manipulate with its own thoughts. After its own thinking, or rather after manipulating with its own thoughts, the machine will come to its own decisions for its future actions.

Following information is written in the section OBJECTIVES OF THE INVENTION of the specification (specification, section OBJECTIVES OF THE INVENTION, the first paragraph). If you gave a robot a command to read the information, the information would also be read to you:

“The way of posing a problem of this invention is to realize a computer system of an artificial intelligence of a cyborg or an android, wherein the computer system of the artificial intelligence of the cyborg or the android is based on one natural language . . . ”

(I have shorted the information to three lines in order to simplify the drawing.)

If you asked a cyborg or an android to read the information, the following would occur (also like a human being). As a matter of course, the information will be processed as the received signal-reaction of the computer system of the artificial intelligence of the cyborg or the android, then as the corresponding association of the computer system of the artificial intelligence of the cyborg or the android, and then as the corresponding thought of the computer system of the artificial intelligence of the cyborg or the android.

First of all, all sensor reactions to the particular signals from all sensor groups of at least five senses equipped with sense organs, wherein one sensor reaction to the particular signals summarizes all reactions of all sensors of all sensor groups of one sense which the particular signals belong to, are summarized with all the sensor groups to a subjective object. This means for example,

the specification, section OBJECTIVES OF THE INVENTION, the first paragraph,—looking like;

the specification, section OBJECTIVES OF THE INVENTION, the first paragraph,—sounding;

the specification, section OBJECTIVES OF THE INVENTION, the first paragraph,—scenting;

the specification, section OBJECTIVES OF THE INVENTION, the first paragraph,—tasting;

the specification, section OBJECTIVES OF THE INVENTION, the first paragraph,—touching.

As a matter of course, some sensor reactions have been initialized with NULL. However, the sensor reactions will be contained in the subjective object. The subjective object (the received signal-reaction of the computer system of the artificial intelligence of the cyborg or the android) will not be handled relative to a time.

Then, the subjective object will be transformed into the associative object (the corresponding association of the computer system of the artificial intelligence of the cyborg or the android). The associative object (the corresponding association of the computer system of the artificial intelligence of the cyborg or the android) will be handled relative to a time which will have been determined from the sensor reactions to the particular signals of the combination that has been contained in the subjective object, or rather from the reactions of the sensors of at least one sensor group to the particular signals. This means that the time will have been obtained from the received signal-reaction of the computer system of the artificial intelligence of the cyborg or the android. The associative object will not be uniquely handled relative to time. The relativity to time will be defined in the one natural language.

After that, the abstract object (the corresponding thought of the computer system of the artificial intelligence of the cyborg or the android) will be created from the associative object. The abstract object (the corresponding thought of the computer system of the artificial intelligence of the cyborg or the android) will be handled relative to the time which will have been determined from the sensor reactions to the particular signals of the combination that has been contained in the subjective object, or rather from the reactions of the sensors of at least one sensor group to the particular signals. This means that the time will have been obtained from the received signal-reaction of the computer system of the artificial intelligence of the cyborg or the android. The abstract object will not be uniquely handled relative to time. The relativity to time will be defined in the one natural language.

The abstract object (the corresponding thought) will be shown in FIG. 8.

Thus, the subjective object from the section OBJECTIVES OF THE INVENTION of the specification, the first paragraph, will be administrated in one natural language, in this case in English. This means, one can further work with the subjective object with the aid of the corresponding thought, think about the corresponding thought, reply to the corresponding thought, and so on.

The corresponding thought contains information which has been summarized from three thoughts, or rather from three abstract objects. The first abstract object is “is” (but rather the abstract object “be”, because “The way of posing a problem of this invention does be . . . ” would be understood) of the class “Be”, the second abstract object is “realize” of the class “Realize”, and the third abstract object is “based” of the class “Base”.

FIG. 9 shows some more examples of the abstract objects that are generated in one natural language.

Following information is located in the section BRIEF SUMMARY OF THE INVENTION of the specification (specification, section BRIEF SUMMARY OF THE INVENTION, the eighth paragraph of the section counting from the end). If you gave a robot a command to read the information, the information would also be read to you:

“The three inventions make it possible either the conversion of a humanoid robot into an android or the conversion of a human being into a cyborg with the artificial component, or with the artificial part,—the artificial intelligence.”

If you asked a cyborg or an android to read the information, the following would take place (also like a human being).

As a matter of course, the information will be processed as the received signal-reaction of the computer system of the artificial intelligence of the cyborg or the android, then as the corresponding association of the computer system of the artificial intelligence of the cyborg or the android, and then as the corresponding thought of the computer system of the artificial intelligence of the cyborg or the android.

First of all, all sensor reactions to the particular signals from all sensor groups of at least five senses equipped with sense organs, wherein one sensor reaction to the particular signals summarizes all reactions of all sensors of all sensor groups of one sense which the particular signals belong to, are summarized with all the sensor groups to a subjective object. This means for example,

the specification, section BRIEF SUMMARY OF THE INVENTION, the eighth paragraph of the section counting from the end,—looking like;

the specification, section BRIEF SUMMARY OF THE INVENTION, the eighth paragraph of the section counting from the end,—sounding;

the specification, section BRIEF SUMMARY OF THE INVENTION, the eighth paragraph of the section counting from the end,—scenting;

the specification, section BRIEF SUMMARY OF THE INVENTION, the eighth paragraph of the section counting from the end,—tasting;

the specification, section BRIEF SUMMARY OF THE INVENTION, the eighth paragraph of the section counting from the end,—touching.

As a matter of course, some sensor reactions have been initialized with NULL. However, the sensor reactions will be contained in the subjective object. The subjective object (the received signal-reaction of the computer system of the artificial intelligence of the cyborg or the android) will not be handled relative to a time.

Then, the subjective object will be transformed into the associative object (the corresponding association of the computer system of the artificial intelligence of the cyborg or the android). The associative object (the corresponding association of the computer system of the artificial intelligence of the cyborg or the android) will be handled relative to a time which will have been determined from the sensor reactions to the particular signals of the combination that has been contained in the subjective object, or rather from the reactions of the sensors of at least one sensor group to the particular signals. This means that the time will have been obtained from the received signal-reaction of the computer system of the artificial intelligence of the cyborg or the android. The associative object will not be uniquely handled relative to time. The relativity to time will be defined in the one natural language.

After that, the abstract object (the corresponding thought of the computer system of the artificial intelligence of the cyborg or the android) will be created from the associative object. The abstract object (the corresponding thought of the computer system of the artificial intelligence of the cyborg or the android) will be handled relative to the time which will have been determined from the sensor reactions to the particular signals of the combination that has been contained in the subjective object, or rather from the reactions of the sensors of at least one sensor group to the particular signals. This means that the time will have been obtained from the received signal-reaction of the computer system of the artificial intelligence of the cyborg or the android. The abstract object will not be uniquely handled relative to time. The relativity to time will be defined in the one natural language.

The abstract object (the corresponding thought) will be shown in FIG. 9.

Thus, the subjective object from the section BRIEF SUMMARY OF THE INVENTION of the specification, the eighth paragraph of the section counting from the end, will be administrated in one natural language, in this case in English. This means, one can further work with the subjective object with the aid of the corresponding thought, think about the corresponding thought, reply to the corresponding thought, and so on.

The corresponding thought contains information which has been summarized from three thoughts, or rather from three abstract objects, from one abstract object “make” of the class “Make” and from two abstract objects “realize” of the class “Realize”.

The computer system of the artificial intelligence of the cyborg or the android which is described in this patent application has already been realized by me and is running in order to define the current state of the computer system of the artificial intelligence of the cyborg or the android, to more precisely describe how my inventions work, and to specify the way how to enable one skilled in the art to realize the computer system of the artificial intelligence of the cyborg or the android.

The computer system of the artificial intelligence of the cyborg or the android, or rather the machine, gives a cyborg or an android, a mentally ill or neurological ill patient or also a human being which was born mentally handicapped the opportunity to live in or to be involved in this world on a healthy mental level.

The computer system, or rather the machine, increases the opportunity to recognize, to catch, and to isolate a criminal or a terrorist as the prevention of criminality or terrorism. Thus, the criminal or the terrorist will have no chance to commit anything against or to operate against mankind, because the criminal or the terrorist may preventively have been identified, arrested, and isolated.

The human brain whose working method is represented by the mind uses a natural language to operate. The computer system of the artificial intelligence of the cyborg or the android can act as an artificial brain of the cyborg. The computer system of the artificial intelligence of the cyborg or the android does not use in its working method a programming language but rather one natural language.

There follow 7 sheets of drawings.

1. A computer system of an artificial intelligence of an android, comprising:
a first plurality of pointers created in a computer random access memory of the computer system of the artificial intelligence of the android as subjective objects, wherein a received signal-reaction is substantiated with each subjective object;
a second plurality of pointers created in the computer random access memory of the computer system of the artificial intelligence of the android as associative objects, wherein an association is substantiated with each associative object;
a third plurality of pointers created in the computer random access memory of the computer system of the artificial intelligence of the android as abstract objects, wherein a thought is substantiated with each abstract object;
at least five senses equipped with sense organs, wherein the senses are a sense of sight, a sense of hearing, a sense of smell, a sense of taste, and a sense of touch, and wherein the senses are built-in parts of the artificial intelligence of the android;
at least one sensor group of each sense organ; and
a sensor network of the computer system, wherein the sensor network summarizes all reactions of all sensors of all sensor groups of all sense organs of all senses into the received signal-reaction.

2. A computer system of an artificial intelligence of a cyborg or an android, comprising:
a plurality of pointers created in a computer random access memory of the computer system of the artificial intelligence of the cyborg or the android, wherein the computer system of the artificial intelligence of the cyborg or the android acts as an artificial brain of the cyborg or the android, as subjective objects, wherein a received signal-reaction is substantiated with each subjective object;
a plurality of pointers created in the computer random access memory of the computer system of the artificial intelligence of the cyborg or the android, wherein the computer system of the artificial intelligence of the cyborg or the android acts as the artificial brain of the cyborg or the android, as associative objects, wherein an association is substantiated with each associative object, each at least one corresponding association corresponding to at least one received signal-reaction;
a plurality of pointers created in the computer random access memory of the computer system of the artificial intelligence of the cyborg or the android, wherein the computer system of the artificial intelligence of the cyborg or the android acts as the artificial brain of the cyborg or the android, as abstract objects, wherein a thought is substantiated with each abstract object, each at least one corresponding thought corresponding to at least one corresponding association;
at least five senses equipped with sense organs, wherein the senses are a sense of sight, a sense of hearing, a sense of smell, a sense of taste, and a sense of touch, and wherein the senses are built-in artificial parts of the artificial intelligence of the cyborg or the android; and
a plurality of classes having the pointers as objects, wherein each received signal-reaction, each corresponding association, and each corresponding thought are the corresponding objects of the same class.

3. The computer system according to claim 2, further comprising:
means for classifying the class of each received signal-reaction, each corresponding association, and each corresponding thought as an action in one natural language.

4. The computer system according to claim 3,
wherein each received signal-reaction, each corresponding association, and each corresponding thought are connected together only by the one natural language.

5. The computer system according to claim 3,
wherein the computer system uses a word in another natural language as a reference to a word in the first natural language for a working method in the first natural language.

6. The computer system according to claim 1,
wherein the subjective object is unique with respect to a complete combination of all sensor reactions to particular signals from all sensor groups of all senses.

7. The computer system according to claim 6,
wherein the computer system does not handle the subjective object relative to a time.

8. The computer system according to claim 6, further comprising:
means for outputting the subjective object, wherein the means for outputting comprises means for splitting the subjective object according to all sensor groups of each sense into the sensor reactions and means for disassembling the sensor reactions into the reactions of the sensors.

9. The computer system according to claim 1,
wherein the associative object knows only a corresponding subjective object.

10. The computer system according to claim 9,
wherein the associative object comprises a complete combination of all sensor reactions to particular signals from all sensor groups of all senses, and
wherein the associative object is unique with respect to a phrase of the associative object, wherein the phrase is related to the sense from which the phrase is determined.

11. The computer system according to claim 9, further comprising:
means for defining the associative object relative to a time,
wherein the means for defining the associative object relative to the time defines the time in one natural language,
wherein the means for defining the associative object relative to the time defines the associative object not uniquely relative to the time, and
wherein the means for defining the associative object relative to the time obtains the time from the corresponding subjective object.

12. The computer system according to claim 9, further comprising:
means for cleaning up the associative object,
wherein the means for cleaning up the associative object temporarily builds an artificial fictitious associative object in a sleeping scenario in a dreaming mode, wherein the artificial fictitious associative object belongs to a same class to which one of last associative objects belongs, wherein the artificial fictitious associative object has at least one equal attribute in common with the one of the last associative objects.

13. The computer system according to claim 1,
wherein the abstract object knows only a corresponding associative object but does not know a corresponding subjective object.

14. The computer system according to claim 13,
wherein the abstract object is unique with respect to a complete combination of words of a vocabulary, wherein the complete combination includes both analytic words and abstract words which are words of a phrase of the association.

15. The computer system according to claim 13,
wherein the abstract object can be unique with respect to the complete combination of the words of the vocabulary, wherein the complete combination includes only the abstract words which are the words of the phrase of the association.

16. The computer system according to claim 13, further comprising:
means for defining the abstract object relative to a time,
wherein the means for defining the abstract object relative to the time defines the time in one natural language,
wherein the means for defining the abstract object relative to the time defines the abstract object not uniquely relative to the time, and
wherein the means for defining the abstract object relative to the time obtains the time from the corresponding subjective object.

17. The computer system according to claim 13,
wherein a reference in another natural language to the abstract object is used for a working method in the other natural language.

18. The computer system according to claim 2, further comprising:
means for implementing a primary key of a database table of a database, the database including at least one database table, each database table having at least one primary key,
wherein means for implementing implements each primary key only using a combination of all columns from the database table.

19. A working method of a computer system of an artificial intelligence of a cyborg or an android, said working method comprising the steps of:
summarizing, subjectively relating to the computer system of the artificial intelligence of the cyborg or the android, wherein the computer system of the artificial intelligence of the cyborg or the android acts as an artificial brain of the cyborg or the android, all reactions of all sensors of all sensor groups of all sense organs of all senses into a received signal-reaction of the computer system of the artificial intelligence of the cyborg or the android,
wherein each sense organ is equipped with at least one sensor group,
wherein each of the senses is equipped with at least one sense organ,
wherein each of the senses is a built-in artificial part of the artificial intelligence of the cyborg or the android,
wherein the senses are at least five senses,
wherein the at least five senses are a sense of sight, a sense of hearing, a sense of smell, a sense of taste, and a sense of touch;
transforming the received signal-reaction into a corresponding association of the computer system of the artificial intelligence of the cyborg or the android, in one natural language,
wherein the computer system of the artificial intelligence of the cyborg or the android acts as the artificial brain of the cyborg or the android,
wherein the computer system analyzes the received signal-reaction in the one natural language with respect to other associations of the computer system of the artificial intelligence of the cyborg or the android,
wherein the computer system completes the received signal-reaction in the one natural language relative to a time, wherein the computer system works in the one natural language, and the computer system completes the received signal-reaction in the one natural language associatively to the computer system of the artificial intelligence of the cyborg or the android,
wherein the computer system works in the one natural language,
wherein at least one corresponding association corresponds with at least one received signal-reaction,
wherein the corresponding association corresponds with the received signal-reaction in the one natural language;
storing the corresponding association after the step of transforming the received signal-reaction into the corresponding association;
analyzing the corresponding association, abstractly relating to the computer system of the artificial intelligence of the cyborg or the android, in the one natural language,
wherein the computer system of the artificial intelligence of the cyborg or the android acts as the artificial brain of the cyborg or the android,
word by word,
with a part of speech,
as a part of a sentence,
with regard to a class classification, a polymorphism, units of measurement,
with regard to an intonation;
transforming the corresponding association into a corresponding thought of the computer system of the artificial intelligence of the cyborg or the android, in the one natural language,
wherein the computer system of the artificial intelligence of the cyborg or the android acts as the artificial brain of the cyborg or the android,
word by word,
with at least one analytic entity,
with having consideration for a word order of a phrase,
relative to the time,
wherein the corresponding thought is classified according to an action in the one natural language,
wherein at least one corresponding thought corresponds with at least one corresponding association,
wherein the corresponding thought corresponds with the corresponding association in the one natural language;
storing the corresponding thought, classified according to the action in the one natural language,
word by word,
with the at least one analytic entity,
with having consideration for the word order of the phrase,
relative to the time;
operating the corresponding thought;
finding the corresponding association again;
extracting the received signal-reaction from the corresponding association; and
returning the received signal-reaction.
